(19) United States
(12) Patent Application Publication
(10) Pub. No.: US 2012/0005610 A1
(43) Pub. Date: Jan. 5, 2012

(54) METHODS, APPARATUS, SYSTEMS AND COMPUTER READABLE MEDIUMS FOR USE IN TRANSFERING INFORMATION TO AND/OR FROM USER DEVICES

(76) Inventors: Dirk Michael Schulze, Reilingen (DE); Lutz Krauss, Talheim (DE)

(21) Appl. No.: 12/827,625

(22) Filed: Jun. 30, 2010

(51) Int. Cl. G06F 3/048

(52) U.S. Cl. 715/771

(57) ABSTRACT

In one aspect, a method comprises: receiving, by a processing system, requests for information from a plurality of user devices, each of the plurality of user devices having a user interface with capabilities, the capabilities of the user interface of each user device being different than the capabilities of the user interface of each of the other user devices; sending each of a plurality of sets of information to a respective one of the plurality of user devices; and sending information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

### FIELD

Some embodiments of the present invention relate to transferring information to and/or from user devices.

### BACKGROUND

Businesses and/or other types of entities often collect and/or use information in the course of their operations. The information collected and/or used by an entity is often stored in one or more databases, which may be part of a processing system operated by, and/or on behalf of, the entity, such as for example an enterprise resource planning (ERP) system provided by SAP AG headquartered in Walldorf, Germany.

From time to time, the information stored in the one or more databases of an entity may be supplied to one or more user devices, such as for example, one or more desktop or laptop computers operated by one or more users (e.g., employees of the entity) and coupled, directly or indirectly, to the processing system.

### SUMMARY

From time to time, it may also be desirable to supply information to other types of user devices (i.e., other than desktop and laptop computers) such as for example smart phones

However, many of such user devices have form factors that are very different than those of desktop and laptop computers. Indeed, in view of the many different types and manufacturers of smart phones, smart phones frequently have form factors that are very different from one another. Moreover, in some embodiments, it may be desirable to present the information in a way that preserves the “look and feel” of the user interface provided by each user device.

Requiring a processing system to track and/or compensate for each of the different form factors and/or user interfaces may become a burden on the processing system.

In some embodiments, to help alleviate one or more of the issues set forth above, a processing system may send information to user devices, and the user devices may determine what to display and/or how to display it, at least in part.

In one aspect, a method comprises: receiving, by a processing system, requests for information from a plurality of user devices, each of the plurality of user devices having a user interface with capabilities, the capabilities of the user interface of each user device being different than the capabilities of the user interface of each of the other user devices; providing, by the processing system, a plurality of sets of information, each of the plurality of sets of information including a plurality of items for potential display in a view provided by the user interface of a respective one of the plurality of user devices; providing, by the processing system, information associated with the plurality of sets of information; sending each of the plurality of sets of information to a respective one of the plurality of user devices; and sending the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

In another aspect a computer readable storage medium having instructions stored thereon, the instructions being executable by a machine to result in a method comprising: receiving, by a processing system, requests for information from a plurality of user devices, each of the plurality of user devices having a user interface with capabilities, the capabilities of the user interface of each user device being different than the capabilities of the user interface of each of the other user devices; providing, by the processing system, a plurality of sets of information, each of the plurality of sets of information including a plurality of items for potential display in a view provided by the user interface of a respective one of the plurality of user devices; providing, by the processing system, information associated with the plurality of sets of information; sending each of the plurality of sets of information to a respective one of the plurality of user devices; and sending the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

In another aspect, an apparatus comprises: a processing system to (i) receive requests for information from a plurality of user devices, each of the plurality of user devices having a user interface with capabilities, the capabilities of the user interface of each user device being different than the capabilities of the user interface of each of the other user devices; (ii) provide a plurality of sets of information, each of the plurality of sets of information including a plurality of items for potential display in a view provided by the user interface of a respective one of the plurality of user devices, (iii) provide information associated with the plurality of sets of information, (iv) send each of the plurality of sets of information to a respective one of the plurality of user devices; and (v) send the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

In another aspect, a method comprises: sending, by a user device, a request for information; receiving, by the user device, a set of information that includes a plurality of items for potential display in a view provided by a user interface of the user device; receiving information associated with the set of information; selecting at least one of the items included in the set of information for display in a view provided by the user interface of the user device based at least in part on the information associated with the set of information and capabilities of the user interface of the user device; and displaying the selected at least one item in a view provided by the user interface of the user device.

In another aspect, a computer readable storage medium having instructions stored thereon, the instructions being executable by a machine to result in a method comprising: sending, by a user device, a request for information; receiving, by the user device, a set of information that includes a plurality of items for potential display in a view provided by a user interface of the user device; receiving information associated with the set of information; selecting at least one of the items included in the set of information for display in a view provided by the user interface of the user device based at least in part on the information associated with the set of information and capabilities of the user interface of the user device; and displaying the selected at least one item in a view provided by the user interface of the user device.

In another aspect, apparatus comprises: a user device to send a request for information, receive a set of information that includes a plurality of items for potential display in a view provided by a user interface of the user device, receive information associated with the set of information, select at least one of the items included in the set of information for display in a view provided by the user interface of the user device based at least in part on the information associated with the set of information and capabilities of the user interface of the user device; and display the selected at least one item in a view provided by the user interface of the user device.

In another aspect, a method comprises: sending a request for information from a user device to a processing system; receiving a set of information at the user device, the set of information including a plurality of items for potential display in a view provided by a user interface of the user device; sending a request to submit information from the user device to the processing system; and receiving a response at the user device confirming that the information from the user device was submitted.

In another aspect, a system comprises: a user device to send a request for information to a processing system and to receive a set of information from the processing system, the set of information including a plurality of items for potential display in a view provided by a user interface of the user device; the user device further to send a request to submit information to the processing system and to receive a response confirming that the information from the user device was submitted to the processing system.

This summary is not intended to be exhaustive and/or limiting. For example, while some aspects are described in this summary, other aspects may not be described in this summary but rather may be apparent from the description, drawings and/or claims which follow. Nor are the various portions of the aspects described in this summary, and/or any possible advantages described in this summary, required in every aspect.

### BRIEF DESCRIPTION OF THE DRAWINGS

FIG. 1A is a block diagram of a system according to some embodiments.

FIG. 1B is a flow chart of a method, in accordance with some embodiments.

FIG. 1C is a flow chart of a method, in accordance with some embodiments.

FIG. 2 is a schematic representation of a table that includes information, in accordance with some embodiments.

FIG. 3 is a schematic representation of a table that includes information, in accordance with some embodiments.

FIG. 4 is a schematic representation of a table that includes information, in accordance with some embodiments.

FIG. 5 is a representation a user device and a view in a user interface that may be provided thereby, in accordance with some embodiments.

FIG. 6 is a representation of a mobile user device and a view in a user interface that may be provided thereby, in accordance with some embodiments.

FIGS. 7A-7D are a representation of a model that may be used in transferring information to and/or from a user device, in accordance with some embodiments.

FIGS. 8A-8B are a representation of instance that may be used in transferring information to a user device, in accordance with some embodiments.

FIGS. 9A-9B are a representation of instance that may be used in transferring information from a user device, in accordance with some embodiments.

FIG. 10 is a flow chart of a method, in accordance with some embodiments.

FIG. 11A is a flow chart of a method, in accordance with some embodiments.

FIGS. 11B-11C is a flow chart of a method, in accordance with some embodiments.

FIG. 12 is a block diagram of a portion of a processing system, in accordance with some embodiments.

FIG. 13 is a block diagram of a portion of a user device, in accordance with some embodiments.

FIG. 14 is a block diagram of an architecture, in accordance with some embodiments.

### DETAILED DESCRIPTION

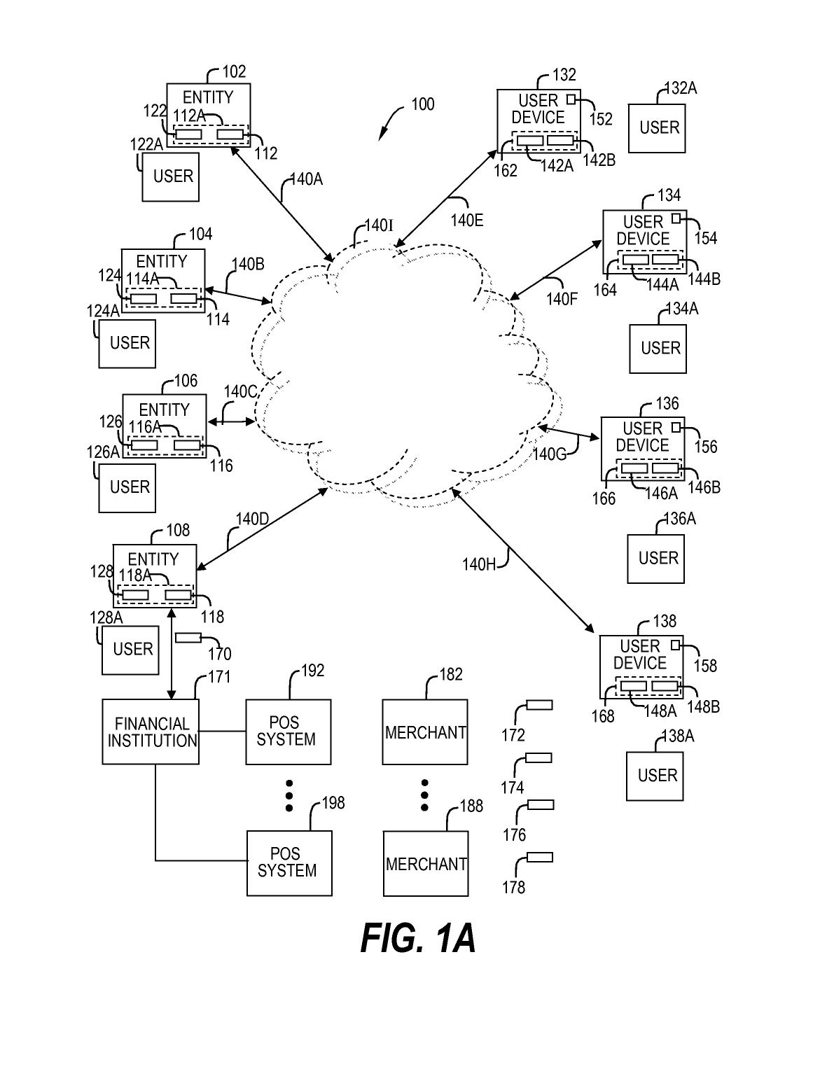

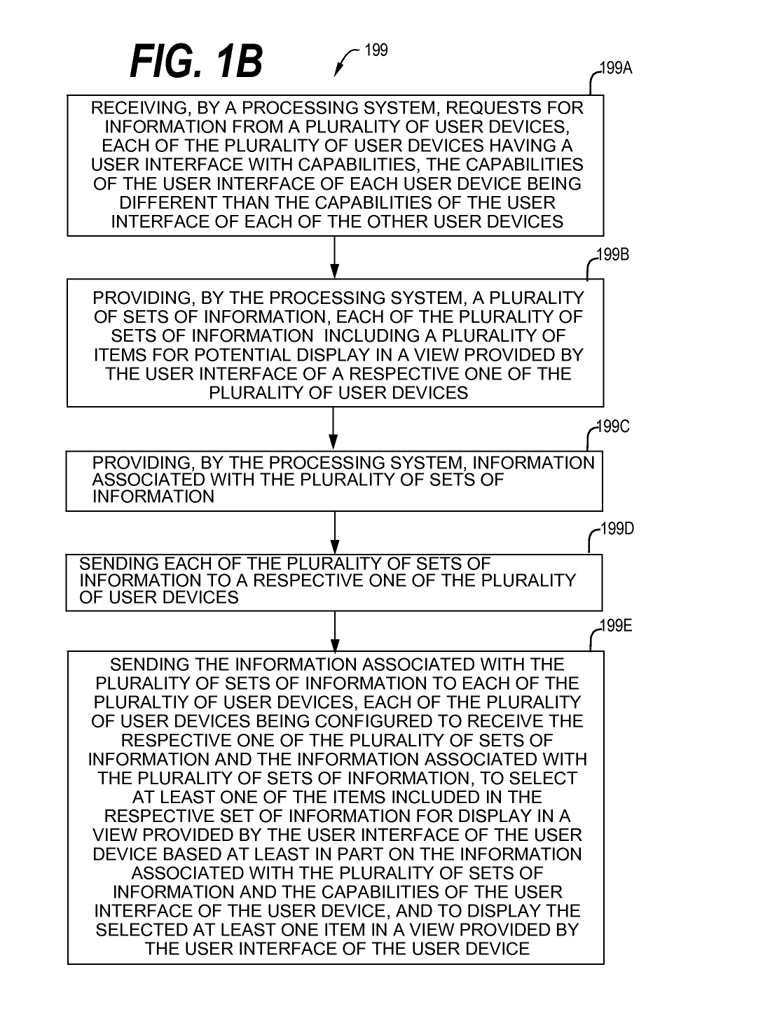

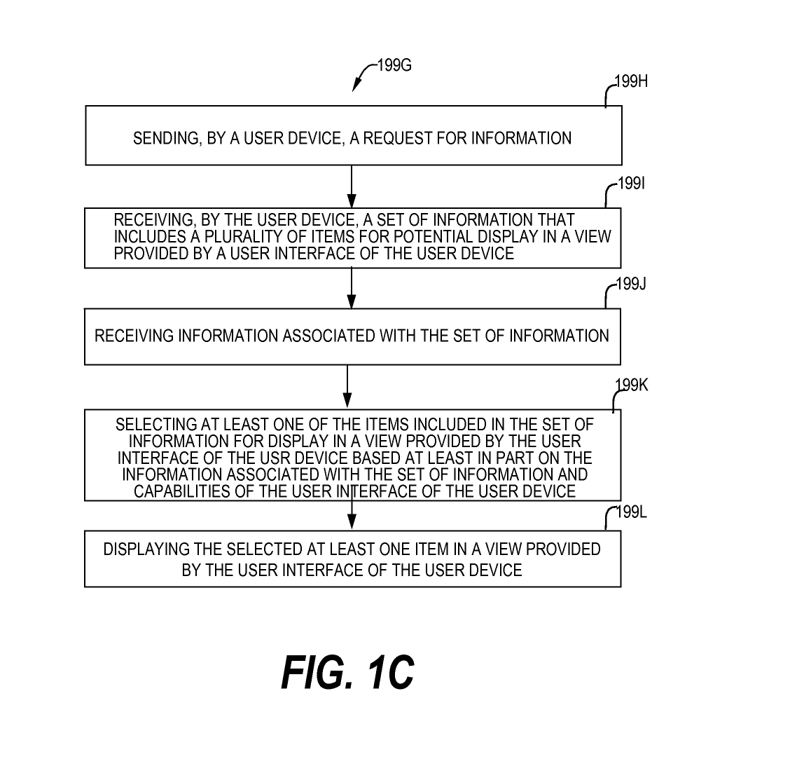

FIG. 1A is a block diagram of a system 100 in accordance with some embodiments. Referring to FIG. 1, the system 100 includes a plurality of businesses and/or other type(s) of entities 102-108. One or more of the entities 102-108 may collect and/or use information in the course of its operations. The information collected and/or used by an entity may be stored in one or more databases, which in turn may part of a processing system that is operated by, and/or on behalf of, the entity (e.g., for use in the course of operations of the entity). For example, the information collected and/or used by entities 102-108 may be stored in databases 112-118, respectively. The databases 112-118 may be part of processing systems 112A-118A, respectively, one or more of which may be an enterprise resource planning (ERP) system, such as, for example an ERP system provided by SAP AG™ headquartered in Walldorf, Germany, operated by, and/or on behalf of, the entities 102-108, respectively. The processing systems 112A-118A may include user devices 122-128 operated by users 122A-128A. In some embodiments, user devices 122-128 comprise desktop and/or laptop computers.

The system 100 may further include a plurality of mobile user devices, e.g., mobile user devices 132-138, which may be operated by a plurality of users 132A-138A, respectively, and coupled to one or more of the entities 102-108 via one or more communication links, e.g., communication links 140A-140I. In some embodiments, one or more of the mobile user devices 132-138 comprises a smart phone and/or other type of smart, hand held mobile user device.

In some embodiments, a smart phone comprises an IPHONE™ (or other smart phone) manufactured by APPLE™, a BLACKBERRY™ (or other smart phone) manufactured by RIM™, a smart phone manufactured by SONY™, a smart phone manufactured by NOKIA™, a smart phone manufactured by PALM™, a smart phone manufactured by MOTOROLA™, a smart phone manufactured by LG™, a smart phone manufactured by MOTOROLA™, a smart phone manufactured by HP™, a smart phone manufactured by GOOGLE™ or any other type of smart phone. In some embodiments, a smart device comprises an IPAD™ or IPOD™ manufactured by APPLE™ or any other type of smart device manufactured by any other manufacturer.

Each of the mobile user devices may include one or more input devices and one or more output devices. For example, the mobile user devices 132-138 may include input devices 142A-148A, respectively, and display devices 142B-148B, respectively.

Each of the mobile user devices may further include one or more processors that executes one or more application programs and communicate with one or more of the input devices and/or one or more of the output devices to provide one or more user interface. For example, the mobile user devices 132-138 may include processors 152-158, respectively, that execute one or more application programs and communicate with the input devices 142A-148A, respectively, and/or the display devices 142B-148B, respectively, to provide user interfaces 162-168, respectively.

In some embodiments, one or more of the user device2 122-128, 132-138 may, execute a browser program that receives information from a local server and/or a remote web server. As used herein, the term “web” site or server may be associated with any resource provided via a communication network such as the Internet.

In some embodiments, it is desirable to have the ability to transfer information between a processing system, e.g., one or more of processing systems 112A-118A, of one or more of the entities, e.g., one or more of entities 102-108, and one or more of the user devices, e.g., one or more of user devices 122-128, 132-138.

For example, in some embodiments, the users 132A-138A may be employees of one of the entities 102-108, e.g., entity 108, and the information collected and/or used by the entity 108 may include information 170 from a financial institution 171 describing credit card transactions initiated by the employees (e.g., users 132A-138A) using credit cards 172-178 issued at the request of the entity 108 for use by the employees. The credit card transactions may involve the purchase of goods and/or services from merchants 182-188 having point of sale (POS) systems 192-198, respectively, coupled, directly or indirectly, to the financial institution 171, which in some embodiments, may be the financial institution that issued the credit cards 172-178.

In such embodiments, it may be desirable to assign each of the credit card transactions to a business trip (or other business of the entity) for which the credit card transaction was made, or alternatively, to another entity that will be responsible for paying the amount of the credit card transaction.

Thus, it may be desirable to provide an employee with information describing credit card transactions initiated by that employee and to ask the employee to indicate whether those credit card transactions were associated with a business trip taken by the employee.

However, many of the user devices, e.g., 122-128, 132-138, may have different form factors. Moreover, in some embodiments, it may be desirable to present the information in a way that preserves the “look and feel” of the user interface provided by each user device. Requiring a processing system to track and/or compensate for each of the different form factors and/or user interfaces may become a burden on the processing system.

To help alleviate one or more of the issues above, in some embodiments, a processing system may send information to user devices, and the user devices may determine what to display and/or how to display it, at least in part.

FIG. 1B is a flow chart 199 of a method according to some embodiments. In some embodiments, one or more portions of the method may be performed by one or more processing systems, e.g., one or more of processing systems 112A-118A. It should be noted that the method and of the other methods described herein may be performed by hardware, software (including low level language code), or any combination of these approaches. For example, a storage medium may store thereon instructions that when executed by a machine result in performance according to any of the embodiments described herein.

In some embodiments, one or more portions of the method may be performed in association with transferring information between a processing system of an entity, e.g., one or more of entities 102-108, and one or more user devices, e.g., one or more of user devices 122-128, 132-138. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method.

Referring to FIG. 1B, at 199A, the method may include receiving, by a processing system, requests for information from a plurality of user devices, each of the plurality of user devices having a user interface with capabilities, the capabilities of the user interface of each user device being different than the capabilities of the user interface of each of the other user devices.

At 199B, the method may further include, providing, by the processing system, a plurality of sets of information, each of the plurality of sets of information including a plurality of items for potential display in a view provided the user interface of a respective one of the plurality of user devices.

At 199C, the method may further include providing, by the processing system, information associated with the plurality of sets of information.

As further described below, in some embodiments, the providing of information associated with the plurality of sets of information comprises providing a model that includes the information associated with the plurality of sets of information. In some embodiments, the providing a plurality of sets of information comprises providing a plurality of instances of the model, each of the plurality of instances of the model including a respective one of the plurality of sets of information.

At 199D, the method may further include sending each of the plurality of sets of information to a respective one of the plurality of user devices.

At 199E, the method may further include sending the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

In some embodiments, the at least one of the items selected by one of the plurality of user devices are not exactly the same as would be selected by one or more other ones of the plurality of user devices had the other ones of the plurality of user devices received the set of information received by the one of the plurality of devices. For example, one or more of the one or more other ones of the plurality of user devices may (i) exclude one or more of the items selected by the one of the plurality of user devices and/or (ii) include one or more of the items not selected by the one of the plurality of user devices.

In some embodiments, each of the plurality of user devices is further configured to determine visual characteristics for the at least one of the items displayed in the view provided by the user interface of the user device based at least in part on the information associated with the plurality of sets of information and the capabilities of the user interface of the user device, and to display the selected at least one item in the view provided by the user interface of the user device in accordance with the visual characteristics determined by the user device.

In some embodiments, the method further comprises receiving, by the processing system, information from at least one of the user devices and performing, by the processing system, at least one check of the received information based at least in part on the information associated with the plurality of sets of information.

In some embodiments, the information associated with the plurality of sets of information comprises information indicating the items of the plurality of items for which display in the view provided by the user interface of the user device is optional.

In some embodiments, a first one of the items is a first description of a subject, a second one of the items is a second description of the subject, the second description of the subject being longer than the first description of the subject, and wherein each user device of the plurality of user devices is configured to select only one of the first description of the subject and the second description of the subject for display in the view provided by the user interface.

FIG. 1C is a flow chart 199G of a method according to some embodiments. In some embodiments, one or more portions of the method may be performed by one or more user devices, e.g., one or more of user devices 122-128, 132-138. It should be noted that the method and of the other methods described herein may be performed by hardware, software (including low level language code), or any combination of these approaches. For example, a storage medium may store thereon instructions that when executed by a machine result in performance according to any of the embodiments described herein.

Referring to FIG. 1C, at 199H, the method may include sending, by a user device, a request for information.

At 1991, the method may further include receiving, by a user device, a set of information that includes a plurality of items for potential display in a view provided by a user interface of the user device.

At 199J, the method may further include receiving, by the user device, information associated with the set of information.

At 199K, the method may further include selecting, by the user device, at least one of the items included in the set of information for display in a view provided by the user interface of the user device based at least in part on the information associated with the set of information and capabilities of the user interface of the user device.

At 199L, the method may further include displaying the selected at least one item in a view provided by the user interface of the user device.

In some embodiments, each of the plurality of user devices is further configured to determine visual characteristics for the at least one of the items displayed in the view provided by the user interface of the user device based at least in part on the information associated with the plurality of sets of information and the capabilities of the user interface of the user device, and to display the selected at least one item in the view provided by the user interface of the user device in accordance with the visual characteristics determined by the user device.

In some embodiments, the information associated with the plurality of sets of information comprises information indicating the items of the plurality of items for which display in the view provided by the user interface of the user device is optional.

In some embodiments, a first one of the items is a first description of a subject, a second one of the items is a second description of the subject, the second description of the subject being longer than the first description of the subject, and wherein each user device of the plurality of user devices is configured to select only one of the first description of the subject and the second description of the subject for display in the view provided by the user interface.

Some embodiments are disclosed below with respect to transferring information associated with credit card transactions. It should be understood however, that the methods, apparatus, systems and computer readable mediums described herein are not limited to use in association with the transfer of information associated with credit card transactions, but rather may be used in association with the transfer of any type or types of information. Some embodiments may be useful in connection with reserving and/or ordering products and/or services provided by an entity (e.g., reserving a hotel room provided by a hotel and/or ordering an item from a menu of items provided by a restaurant), reviewing and/or updating orders for products and/or services provided by an entity.

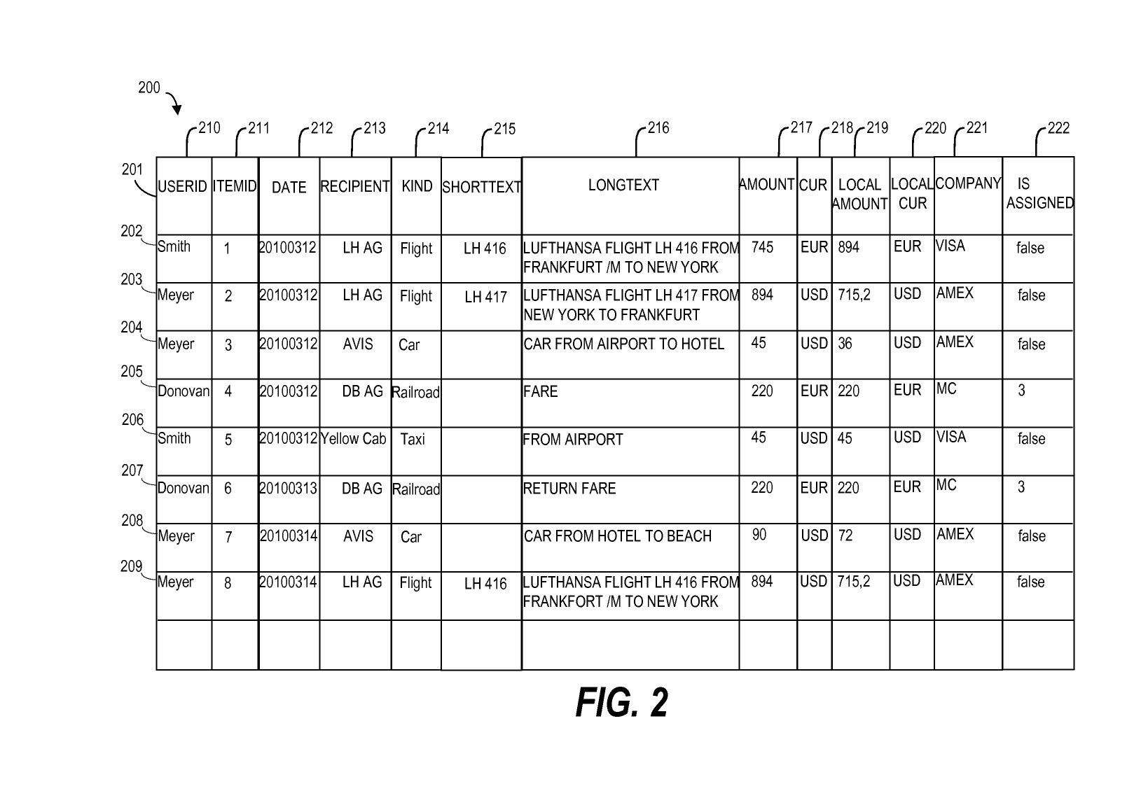

FIG. 2 is a schematic representation of a table 200 that includes information associated with credit card transactions initiated by employees, in accordance with some embodiments. In some embodiments, the information shown in table 200, as well as other information, may be stored in a database, e.g., one or more of databases 112-118.

Referring to FIG. 2, the table 200 may include a plurality of rows 201-209 and a plurality of columns 210-222. The first row 201 may define a header that includes a plurality of names (e.g., USERID, ITEMID, DATE, RECIPIENT, KIND, SHORTTEXT, LONGTEXT, AMOUNT, CURRENCY, LOCAL AMOUNT, LOCALCURRENCY, COMPANY AND ISASSIGNED). Each of the names may be associated with a respective one of the plurality of columns 210-222 and may indicate the type of information that is listed in the respective one of the plurality of columns 210-222.

Each of the other rows 202-209 may define a line item (sometimes referred to herein as an entry) in the table 200 and may be associated with a respective credit card transaction. Thus, one of the rows, e.g., row 202, may include a USERID, ITEMID, DATE, RECIPIENT, KIND, SHORTTEXT, LONGTEXT, AMOUNT, CURRENCY, LOCAL AMOUNT, LOCALCURRENCY, COMPANY AND ISASSIGNED associated with a first credit card transaction. Another one of the rows, e.g., row 203, may include a USERID, ITEMID, DATE, RECIPIENT, KIND, SHORTTEXT, LONGTEXT, AMOUNT, CURRENCY, LOCAL AMOUNT, LOCALCURRENCY, COMPANY AND ISASSIGNED associated with a second credit card transaction. And so on.

In some embodiments, USERID may indicate a name or other identifier (ID) assigned to an employee, ITEMID may indicate an identifier (ID) assigned to a particular credit card transaction, DATE may indicate a date of the credit card transaction, RECIPIENT may indicate a name of a recipient of a payment made in settlement of the credit card transactions, KIND may indicate a classification of the goods and/or services that were the subject of the credit card transaction, SHORTTEXT may indicate a short text description (i.e., a description that is shorter than a description indicated by LONGTEXT) of goods and/or services that were the subject of the credit card transaction, LONGTEXT may indicate a long text description (i.e., a description that is longer than the description indicated by SHORTTEXT) of goods and/or services that were the subject of the credit card transaction, AMOUNT may indicate a monetary amount of the credit card transaction, CURRENCY may indicate a currency used in the credit card transaction, LOCALAMOUNT may indicate the monetary amount of the credit card transaction in terms of a local currency, LOCALCURRENCY may indicate the local currency, COMPANY may indicate a name of a credit card issuer, and ISASSIGNED may indicate whether or not the credit card transaction has been assigned to a business trip and/or otherwise closed out, for example, if the credit card transaction is assigned to a business trip, then ISASSIGNED may indicate a travel ID of a business trip to which the credit card transaction is assigned, and if the credit card transaction is not assigned to a business trip and/or closed out, ISASSIGNED may indicate so, e.g., by “false”.

As can be seen, in the illustrated embodiment, rows 202 and 206 define entries associated with credit card transactions initiated using a credit card assigned to Smith. Rows 203-204 and 208-209 define entries associated with credit card transactions initiated using a credit card assigned to Meyer. Rows 205 and 207 define entries associated with credit card transactions initiated using a credit card assigned to Donovan.

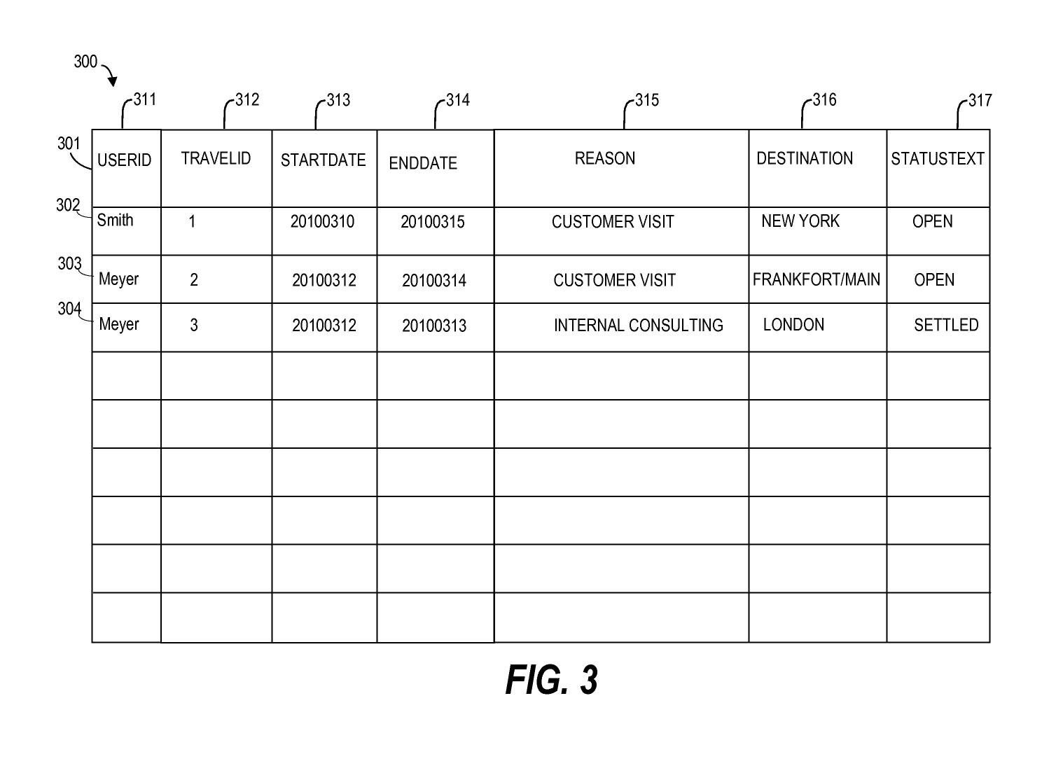

FIG. 3 is a schematic representation of a table 300 that includes information associated with business trips that have been approved and taken and/or will be taken (i.e., travel) by employees, in accordance with some embodiments. In some embodiments, the information shown in table 300, as well as other information, may be stored in a database, e.g., one or more of databases 112-118.

Referring to FIG. 3, the table 300 may include a plurality of rows 301-304 and a plurality of columns 311-317. The first row 301 may define a header that includes a plurality of names (e.g., USERID, TRAVELID, STARTDATE, ENDDATE, REASON, DESTINATION, STATUSTEXT), each of which may be associated with a respective one of the plurality of columns 311-317 and may indicate the type of information that is listed in the respective one of the plurality of columns 311-317.

Each of the other rows, e.g., rows 302-304, may define a line item (sometimes referred to herein as an entry) in the table 300 and may be associated with a respective business trip that has been applied for by an employee. Thus, in some embodiments, each of such rows may include a USERID, TRAVELID, STARTDATE, ENDDATE, REASON, DESTINATION and STATUSTEXT associated with a first business trip applied for by an employee.

For example, in the illustrated embodiment, row 302 is an entry that is associated with a business trip applied for by an employee associated with a USERID “Smith”. Thus, the row 302 may include the USERID “Smith”, and a TRAVELID, STARTDATE, ENDDATE, REASON, DESTINATION and STATUSTEXT associated with the business trip applied for by the employee associated with the USERID “Smith”. Row 303 is an entry that is associated with a business trip applied for by an employee associated with a USERID “Meyer”. Thus, the row 303 may include the USERID “Meyer”, and a TRAVELID, STARTDATE, ENDDATE, REASON, DESTINATION and STATUSTEXT associated with the business trip applied for by the employee associated with the USERID “Meyer”. And so on.

In some embodiments, USERID may indicate a name or other identifier (ID) assigned to an employee, TRAVELID may indicate an identifier (ID) assigned to a business trip taken (and/or to be taken) by an employee, STARTDATE may indicate a start date for the business trip, ENDDATE may indicate an end date for the business trip, REASON may indicate one or more reasons for the business trip, DESTINATION may indicate a name of a destination for the business trip, and STATUSTEXT may indicate a status of the business trip (e.g., whether the business trip is open or closed out).

In some embodiments, it may be desirable to search the table 200 and the table 300 for and select entries having a USERID associated with a particular employee. For example, it may be desirable to search the table 200 and the table 300 for and select entries having a USERID of Meyer, so as to identity information to provide the employee “Meyer” with the information that is associated with credit card transactions initiated by employee “Meyer” and to ask the employee “Meyer” to indicate whether those credit card transactions were associated with a business trip taken by the employee “Meyer”.

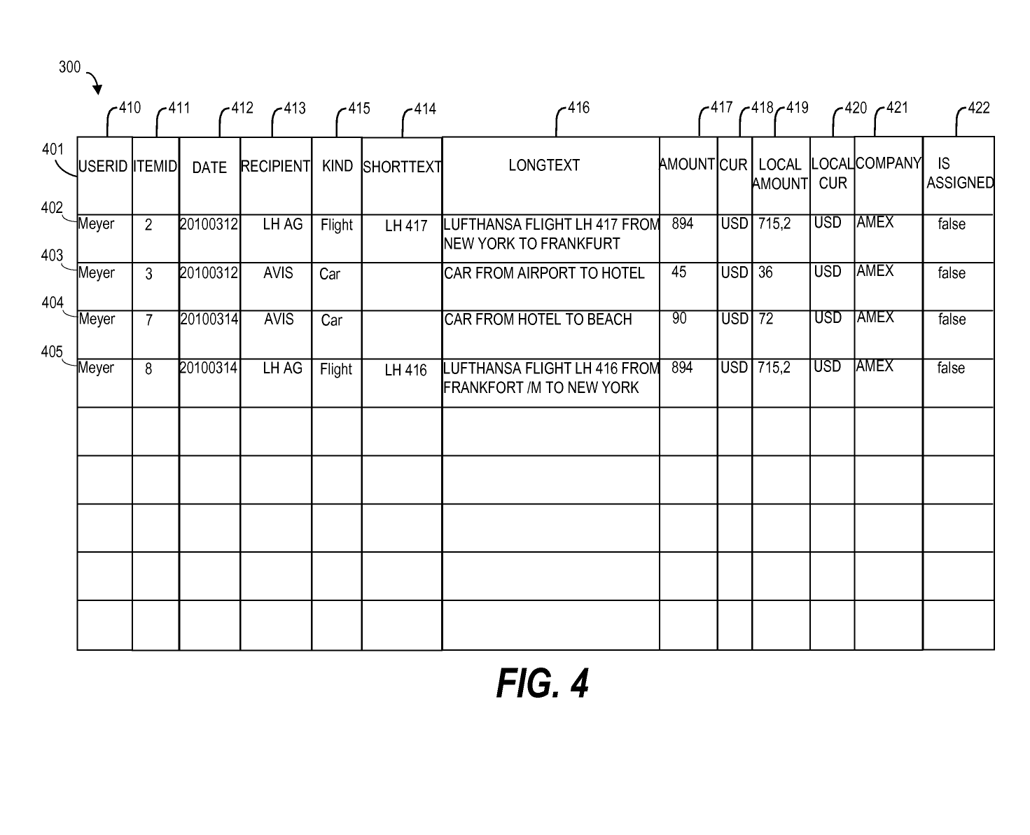

FIG. 4 is a schematic representation of a table 400 that that may be generated by searching the table 200 for and selecting entries having a USERID of Meyer. It should be noted that the entries defined by rows 402-405 in table 400 define entries associated with credit card transactions initiated using a credit card assigned to Meyer and are identical to the entries defined by rows 203-204 and 208-209, respectively, of table 200 in FIG. 2.

As stated above, in some embodiments, it may be desirable to provide an employee with information describing credit card transactions initiated by that employee and to ask the employee to indicate whether those credit card transactions were associated with a business trip taken by the employee.

In some embodiments, the information in table 300 and table 400 may be provided to a user device and the user device may be used to determine, at least in part, what to display and/or how to display it.

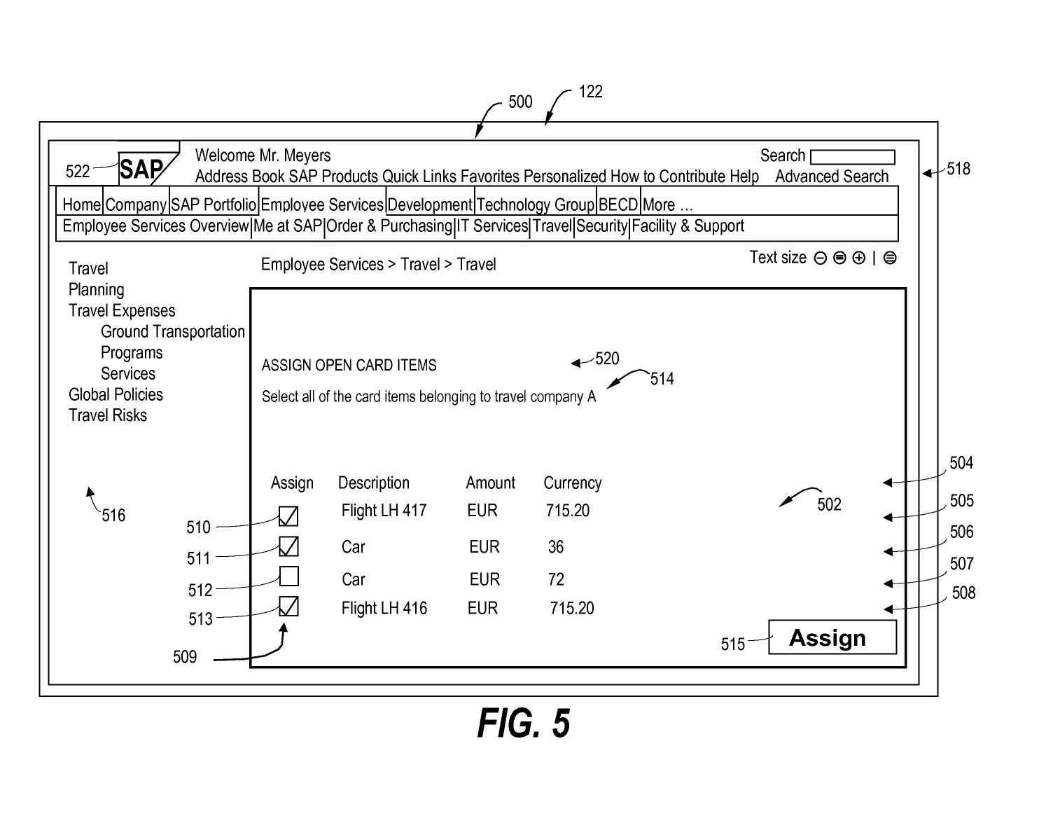

FIG. 5 is a representation of a display portion of a user device, e.g., user device 122, and a view 500 in a graphical user interface that may be used to provide an employee (e.g., Meyer) with information associated with credit card transactions initiated by that employee and to ask the employee to indicate whether those credit card transactions were associated with a business trip taken by the employee, if a large screen is available to display the information, in accordance with some embodiments. In accordance with some embodiments, user device may comprise a personal computer and the display portion of the user device 122 may be a desktop display having a large screen to display information to be provided to the employee.

Referring to FIG. 5, the view 500 includes a table 502 having a plurality of rows 504-508 and a plurality of columns 509-512. The first row 504 defines a header that includes a plurality of names (assigned, description, amount and currency). Each of the names may be associated with a respective one of the plurality of columns 509-512.

Each of the other rows 505-508 defines a line item associated with a respective credit card transaction and includes a description of goods and/or services that were the subject of the credit card transaction, an amount that indicates a monetary amount of the credit card transaction, and a currency used in the credit card transaction. Each of the rows 505-508 also includes a graphical tool disposed in column 509, e.g., check boxes 510-513, respectively, which that may be used in assigning the respective credit card transaction to a business trip.

The view 500 also includes instructions 514 asking the employee to indicate whether the credit card transactions were associated with a business trip taken by the employee (i.e., “Select all of the card items belonging to travel company A”), a graphical tool 515 (e.g., a button) that may be activated or otherwise used to submit the information (e.g., the information indicated by the graphical editing tools 510-513), graphical tools for navigation 516-518, information 520 that identifies the current view in the graphical user interface, i.e., “ASSIGN OPEN CARD ITEMS”, and information 522 that identifies a provider of an application being executed by the user device 122.

In some embodiments, it is desirable to transfer information between one or more of the entities 102-108 and one or more of the users 132A-138A via one or more of the mobile user devices 132-138.

However, the mobile user devices 132-138 often do not have a screen large enough to display the information exactly as is shown in FIG. 5.

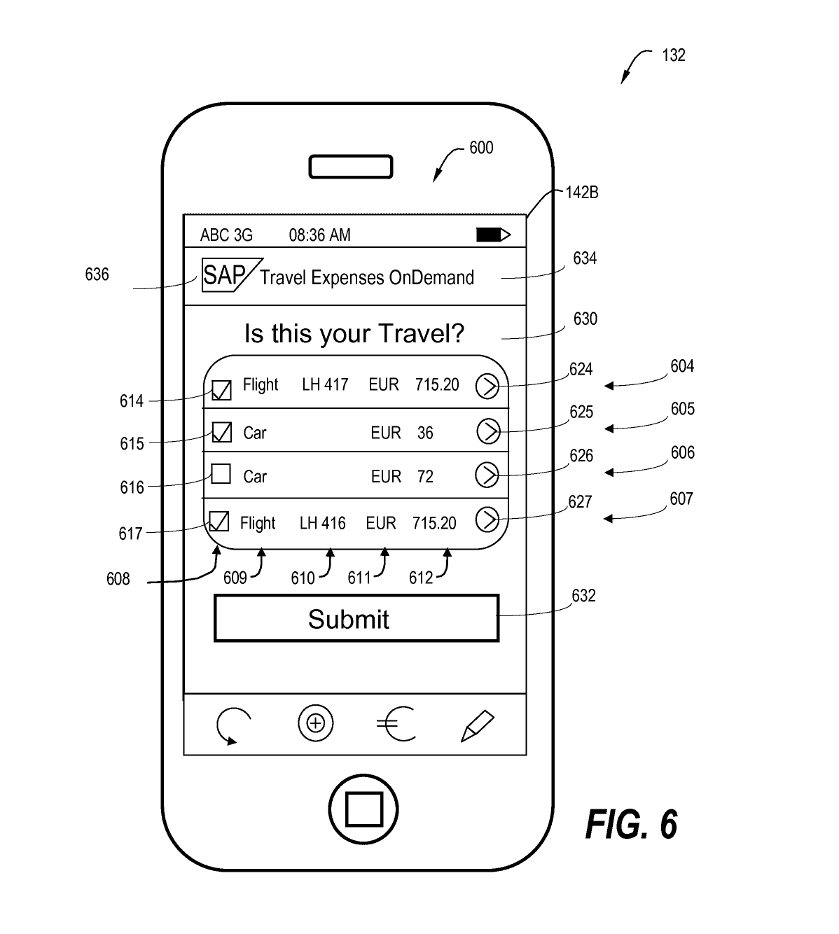

FIG. 6 is a representation a mobile user device, e.g., mobile user device 132, and a view 600 in a user interface, e.g., user interface 162, provided by the mobile user device 132 to provide an employee (e.g., Meyer) with information associated with credit card transactions initiated by that employee and to ask the employee to indicate whether those credit card transactions were associated with a business trip taken by the employee, if a small screen is available to display the information, in accordance with some embodiments.

In accordance with some embodiments, the mobile user device 132 may be a smart phone having a display that is much smaller than the display of the user device 122 represented in FIG. 5. Consequently a much smaller screen is available to display the information to be provided to the employee.

Referring to FIG. 6, it can be seen that the view 600 has noticeable less information than the view 500 of FIG. 5. The view 600 includes a table 602 having a plurality of rows 604-607 and a plurality of columns 608-612. It should be noted that, there is no header row comparable to row 504 in the view 500 of FIG. 5.

Each of the rows 604-607 defines a line item associated with a respective credit card transaction and includes a description of goods and/or services that were the subject of the credit card transaction, a currency used in the credit card transaction and an amount associated with the credit card transaction.

Each of the rows 604-607 may also include a first graphical tool 614-617, respectively, and/or a second graphical tool 624-627, respectively. The first graphical tool may be used in assigning the respective credit card transaction to a business trip. The second graphical tool may be used to request additional information (i.e., information not already displayed in the view 600) for the respective credit card transaction.

The view 600 may also include instructions 630 asking the employee to indicate whether the credit card transactions were associated with a business trip (i.e., “Is this your Travel?”), a graphical tool 632 (e.g., a button) that may be activated or otherwise used to submit the information (e.g., the information indicated by the graphical editing tools 614-617), information 634 that indicates the current view in the graphical user interface (i.e., “Travel Expenses On Demand”) and information 636 that identifies a provider of an application being executed by the mobile user device 132 to provide the view 600 in the graphical user interface.

In some embodiments, a model and instance framework is used in transferring information to and/or from a user device.

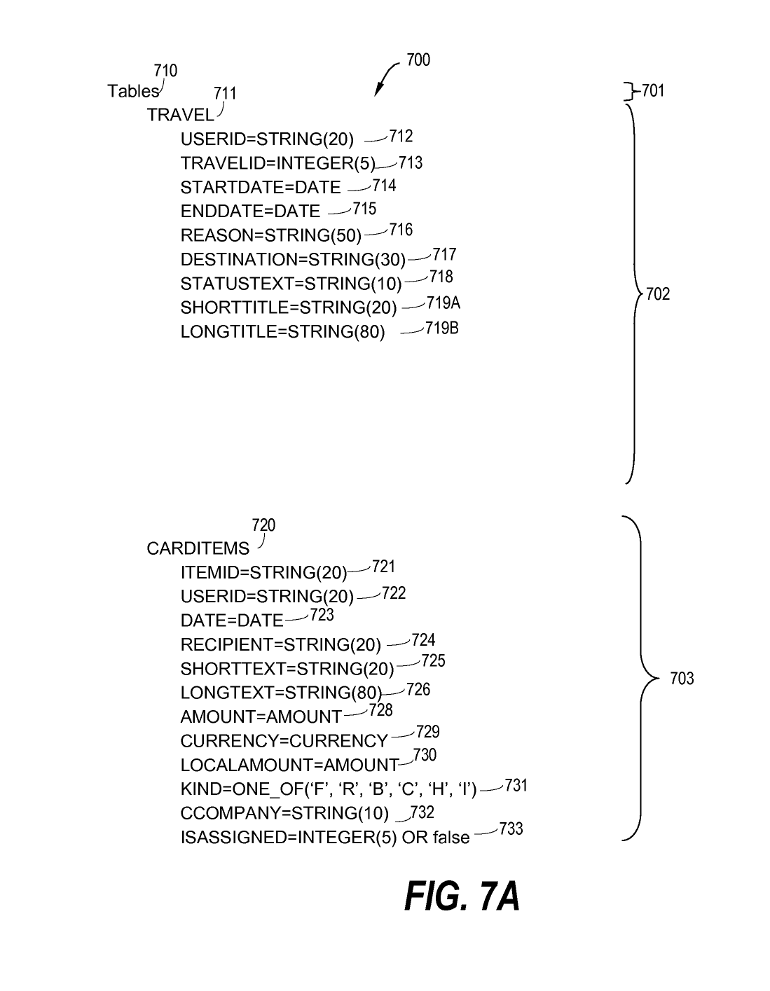

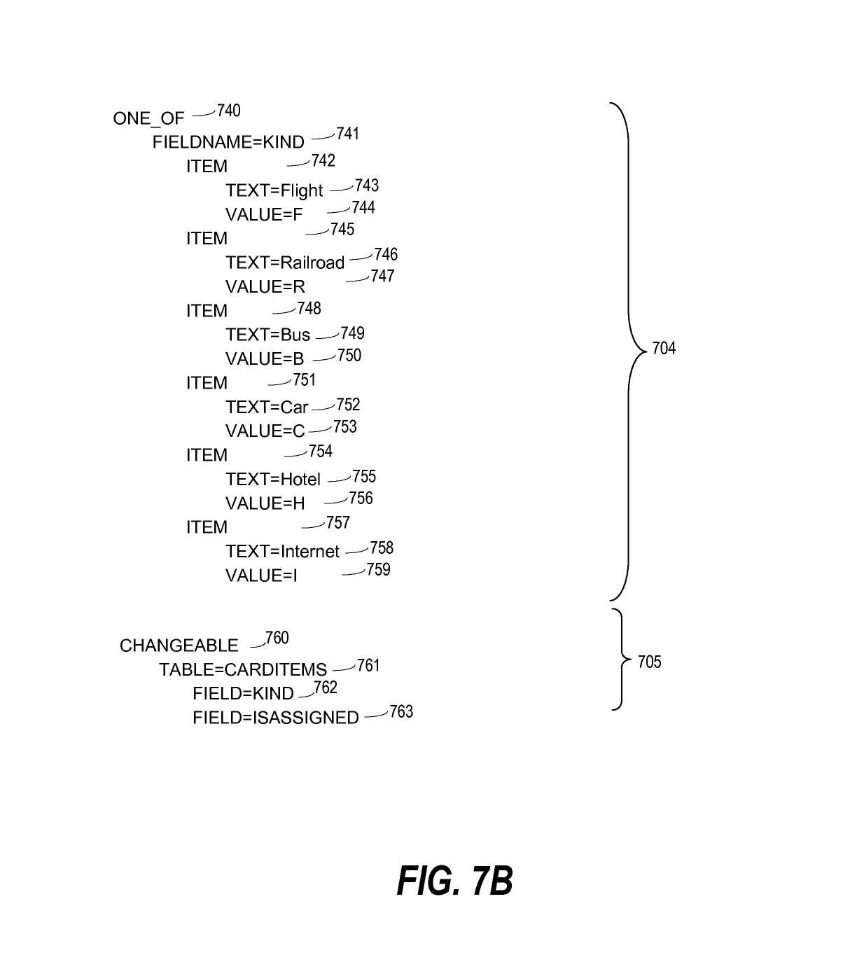

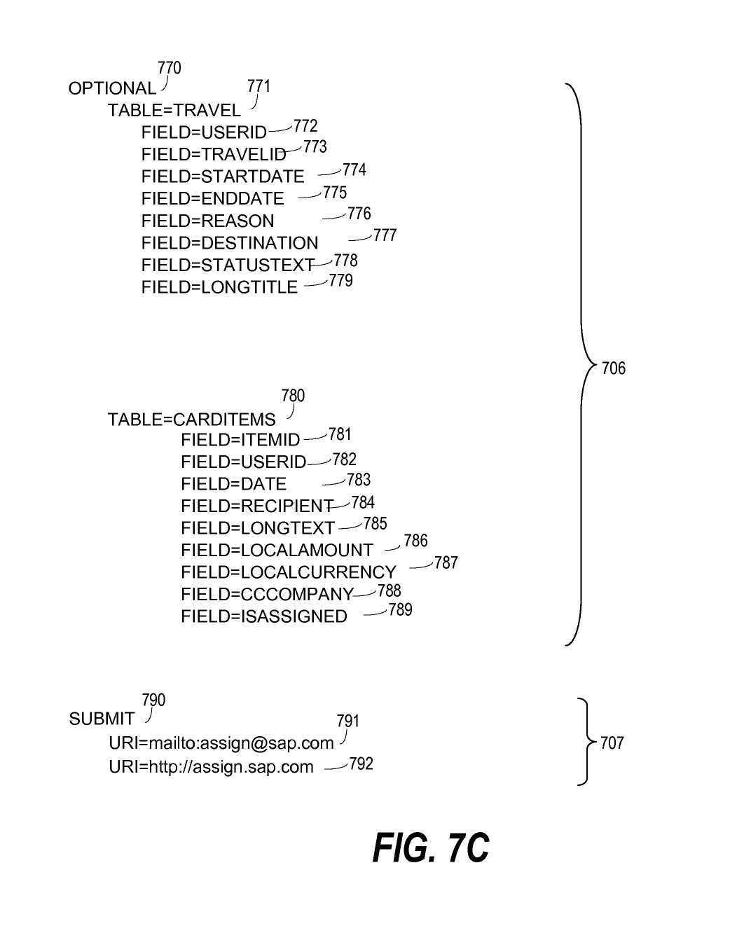

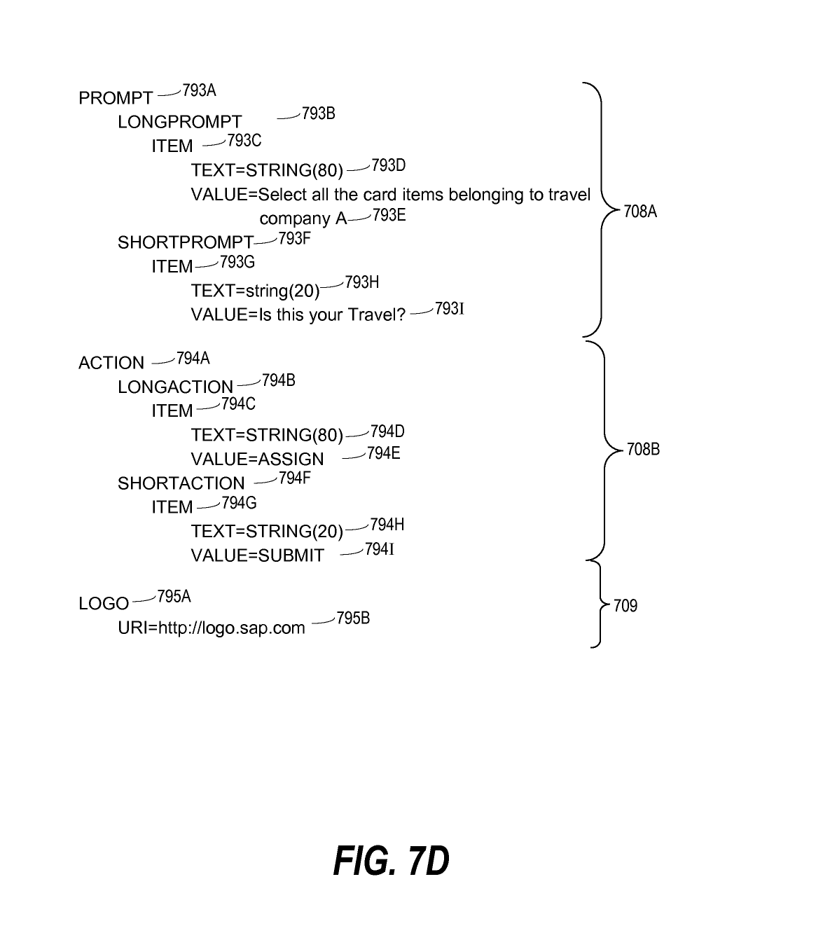

FIGS. 7A-7D are a representation of a model 700 that may be used in transferring information to and/or from a user device, e.g., one or more of user devices 122-128, 132-138, in accordance with some embodiments. In some embodiments, the model 700 may be used to provide an employee (e.g., Meyer) with information associated with credit card transactions initiated by that employee and to ask the employee to indicate whether those credit card transactions were associated with a business trip taken by the employee. In some other embodiments, the information may include one or more other types of information, which may be in addition to and/or in lieu of the information in the illustrated embodiment.

Referring to FIGS. 7A-7D, the model 700 may include ten data structures 701-709. The first data structure 701 may include an entry 710 (e.g., “Tables”) indicating a type of structure that is defined by the model 700. In the illustrated embodiment, the entry 710 (e.g., “Tables”) indicates that the model 700 defines one or more tables.

The second data structure 702 may include a plurality of entries, e.g., entries 711-718 and 719A-719B. A first entry 711 may comprise an identifier (e.g., “TRAVEL”) that identifies the model 700. The other entries 712-718 and 719A-719B may collectively define the types of information that may be part of the model 700 but not part of the table defined by the model 700. For example, in the illustrated embodiment, the entries 712-718 collectively define the types of information that may be used in describing a business trip that has been approved for the employee.

Each of the entries 712-718 and 719A-719B may be associated with, and may define, one of the types of information that may be part of the model 700 but not part of the table defined by the model 700. In the illustrated embodiment, each of the entries 712-718 and 719A-719B includes two fields separated by a delimiter (e.g., “=”). One of the fields may define an identifier (e.g., USERID) for the type of information associated with and defined by the entry. The other field may define a data type (e.g., STRING(20)) for the type of information associated with and defined by the entry.

In the illustrated embodiment, the entry “USERID=STRING(20)” indicates that one type of information that may be part of the model is identified by the identifier USERID and that such type of information is a string of up to twenty (20) characters. The entry “TRAVELID=INTEGER(5)” indicates that another type of information that may be part of the model is identified by the identifier TRAVELID and that such type of information is an integer that includes up to five (5) digits. The entry “STARTDATE=DATE” indicates that another type of information that may be part of the model is identified by the identifier STARTDATE and that such type of information is a date. The entry “ENDDATE=DATE” indicates that another type of information that may be part of the model is identified by the identifier ENDDATE and that such type of information is also a date. The entry “REASON=STRING(50)” indicates that another type of information that may be part of the model is identified by the identifier REASON and that such type of information is a string having a length of up to fifty (50) characters. The entry “DESTINATION=STRING(30)” indicates that another type of information that may be part of the model is identified by the identifier DESTINATION and that such type of information is a string having a length of up to thirty (30) characters. The entry “STATUSTEXT=STRING(10)” indicates that portion of the information is identified by the identifier STATUSTEXT and that such type of information is a string having a length of up to ten (10) characters. The entry “SHORTTITLE=STRING(20)” indicates that another type of information that may be part of the model is identified by the identifier SHORTTITLE and that such type of information is a string having a length of up to twenty (20) characters. The entry “LONGTITLE=STRING(80)” indicates that another type of information that may be part of the model is identified by the identifier LONGTITLE and that such type of information is a string having a length of up to eighty (80) characters.

As stated above with respect to FIG. 3, USERID may indicate a name or other identifier (ID) assigned to an employee, TRAVELID may indicate an identifier (ID) assigned to a business trip taken (and/or to be taken) by an employee, STARTDATE may indicate a start date for the business trip, ENDDATE may indicate an end date for the business trip, REASON may indicate one or more reasons for the business trip, DESTINATION may indicate a name of a destination for the business trip, and STATUSTEXT may indicate a status of the business trip (e.g., whether the business trip is open or closed out).

In addition, SHORTTITLE may indicate a short text description (i.e., a description that is shorter than a description indicated by LONGTITLE) of an application, LONGTITLE may indicate a long text description (i.e., a description that is longer than the description indicated by SHORTTITLE) of the application.

The third data structure 703 may define the types of information that may be included in each entry in the table defined by the model 700. The third data structure 703 may include a plurality of entries, e.g., 720-733. A first entry 720 may comprise an identifier (e.g., “CARDITEMS”) that identifies the data structure 703. The other entries 721-733 may collectively define the types of information that may be included in each entry of the table. For example, in the illustrated embodiment, the entries 721-733 collectively define the types of information that may be used in describing a credit card transaction initiated by an employee.

In some embodiments, each of the entries 721-733 may be associated with, and may define, a one of the types of the information that may be included in an entry of the table. In some embodiments, each of such entries 721-733 may include two fields separated by a delimiter (e.g., “=”). One of the fields may define an identifier (e.g., ITEM ID) for the type of information associated with and defined by the entry. The other field may define the data type (e.g., STRING(20)) for the type of information associated with and defined by the entry.

In the illustrated embodiment, the entry “ITEM ID=STRING(20)” indicates that one type of information that may be part of each entry in the table is identified by an identifier ITEM ID and that such type of information is a string having a length of up to twenty (20) characters. The entry “DATE=DATE” indicates that another type of information that may be part of each entry in the table is identified by an identifier DATE and such type of information is a date. The entry “RECIPIENT=STRING(20)” indicates that another type of information that may be part of each entry in the table is identified by an identifier RECIPIENT and that such type of information is a string having a length of up to twenty (20) characters. The entry “SHORTTEXT=STRING(20)” indicates that another type of information that may be part of each entry in the table is identified by an identifier SHORTTEXT and that such type of information is a string having a length of up to twenty (20) characters. The entry “LONGTEXT=STRING(80)” indicates that another type of information that may be part of each entry in the table is identified by an identifier LONGTEXT and that such type of information is a string having a length of up to eighty (80) characters. The entry “AMOUNT=AMOUNT” indicates that another type of information that may be part of each entry in the table is identified by an identifier AMOUNT and that such type of information is an amount. The entry “CURRENCY=CURRENCY” indicates that another type of information that may be part of each entry in the table is identified by an identifier CURRENCY and that such type of information is a currency. The entry “LOCALAMOUNT=AMOUNT” indicates that another type of information that may be part of each entry in the table is identified by an identifier LOCALAMOUNT and that such type of information is an amount. The entry “KIND=ONE_OF(‘F’, ‘R’, ‘B’, ‘C’, ‘H’, ‘I’) indicates that another type of information that may be part of each entry in the table is identified by an identifier KIND and that such type of information is one of ‘F’, ‘R’, ‘B’, ‘C’, ‘H’ or ‘I’. The entry “ISASSIGNED=INTEGER(5) or false” indicates that another type of information that may be part of each entry in the table is identified by an identifier ISASSIGNED and that such type of information is either an integer that includes up to five (5) digits or alternatively, a string with the characters “false”.

As stated with respect to FIG. 2, USERID may indicate a name or other identifier (ID) assigned to an employee, ITEMID may indicate an identifier (ID) assigned to a particular credit card transaction, DATE may indicate a date of the credit card transaction, RECIPIENT may indicate a name of a recipient of a payment made in settlement of the credit card transactions, KIND may indicate a classification of the goods and/or services that were the subject of the credit card transaction, SHORTTEXT may indicate a short text description (i.e., a description that is shorter than a description indicated by LONGTEXT) of goods and/or services that were the subject of the credit card transaction, LONGTEXT may indicate a long text description (i.e., a description that is longer than the description indicated by SHORTTEXT) of goods and/or services that were the subject of the credit card transaction, AMOUNT may indicate a monetary amount of the credit card transaction, CURRENCY may indicate a currency used in the credit card transaction, LOCALAMOUNT may indicate the monetary amount of the credit card transaction in terms of a local currency, LOCALCURRENCY may indicate the local currency, COMPANY may indicate a name of a credit card issuer, and ISASSIGNED may indicate whether or not the credit card transaction has been assigned to a business trip and/or otherwise closed out, for example, if the credit card transaction is assigned to a business trip, then ISASSIGNED may indicate a travel ID of a business trip to which the credit card transaction is assigned, and if the credit card transaction is not assigned to a business trip and/or closed out, ISASSIGNED may indicate so, e.g., by “false”.

In some embodiments, an instance for use in transferring information to and/or from a user device, e.g., one or more of user devices 122-128, 132-138, is generated based at least in part on the model 700 and information stored in one or more of the databases of an entity.

The fourth data structure 704 may define meanings for values allowed by the ONE_OF. data type. The fourth data structure 704 may include a plurality of entries, e.g., entries 740-759. A first entry 740 may comprise an identifier (e.g., “ONE_OF”) for the data structure. The second entry 741 (FIELDNAME=KIND) may include the identifier (e.g., KIND) for a type of information that may be included in the model and has the data type (e.g., ONE_OF.). The other entries 742-759 may define text meanings for each of the values allowed by the ONE_OF. data type. In the illustrated embodiment, the entries 742-759 indicate that the value F means Flight, the value R means Railroad, the value B means Bus, the value C means Car, the value H means Hotel and that the value I means Internet.

The fifth data structure 705 may be used to identify the types of information in the model that may be changed by a user and/or user device. The fifth data structure 705 may include a plurality of entries, e.g., entries 760-763. A first entry 760 may comprise an identifier (e.g., “CHANGEABLE”) that identifies the data structure 705. The other entries 761-763 may identify the particular types information that may be changed. In the illustrated embodiment, the entries 761-763 indicate that the types of information that are associated with the KIND identifier and the ISASSIGNED identifier may be changed by a user and/or user device.

The sixth data structure 706 may be used to identify the types of information that may be included in the model and are optional to display (i.e., may or may not be displayed) in a user interface to be provided by a user device. The sixth data structure 706 may include a plurality of entries, e.g., entries 770-789. A first entry 770 may comprise an identifier (e.g., “OPTIONAL”) that identifies the data structure 706. The other entries 771-789 may identify the identifiers for the types of information that are optional to display. In the illustrated embodiment, the entries 771-779 indicate that the types of information that are associated with identifiers USERID, TRAVEL ID, STARTDATE, ENDDATE, REASON, DESTINATION, STATUSTEXT, LONGTITLE are optional to display in the user interface provided by the user device. The entries 780-789 indicate that the types of information that are associated with identifiers ITEM ID, USERID, DATE, RECIPIENT, LONGTEXT, LOCALAMOUNT, LOCALCURRENCY, CCCOMPANY and ISASSIGNED are also optional to display in the user interface provided by the user device.

In some embodiments, any types of information that are not identified as being changeable are, by default, not changeable.

The seventh data structure 707 may be used to identify one or more service to which requests may be submitted. The seventh data structure 707 may include a plurality of entries, e.g., entries 790-792. A first entry 790 may comprise an identifier (e.g., “SUBMIT”) that identifies the data structure 707. The other entries 791-792 may identify each of the services. In the illustrated embodiment, the entry 791 indicates that a unified resource identifier (URI) for one service is “mailto://assign@sap.com”. The entry 792 indicates that a unified resource identifier (URI) for another service is “http://assign.sap.com”. In some embodiments requests sent to “mailto://assign@sap.com” will be encapsulated in an email message. In some embodiments requests sent to “http://assign.sap.com” will be encapsulated in a hypertext transfer protocol (http) message.

The eighth data structure 708A may define descriptions of text prompts that may be used to prompt a user. The eighth data structure 708A may include a plurality of entries, e.g., entries 793A-7931. A first entry 793A may comprise an identifier (e.g., “PROMPT”) that identifies the data structure. The second entry 793B may include the identifier (e.g., LONGPROMPT) for a description of a text prompt that may be used to prompt a user. The third through fifth entries 793C-793E may indicate that such description is a string having a length of up to eighty (80) characters, and that in this model, it comprises the string “Select all of the card items related to travel company A”. The sixth entry 793F may include the identifier (e.g., SHORTPROMPT) for a description of a text prompt that may be used to prompt a user. The seventh through ninth entries 793G-793I may indicate that such description is a string having a length of up to twenty (20) characters, and that in this model, it comprises the string “Is this your Travel?”. In the illustrated embodiment, SHORTPROMPT is a short description (i.e., a description that is shorter than a prompt indicated by LONGPROMPT), LONGPROMPT is a long description (i.e., a description that is longer than the description indicated by SHORTPROMPT). In some embodiments, one of the descriptions may be optional to display in a view in the user interface provided by the user device. In some embodiments, the long description is the optional text prompt.

The ninth data structure 708B may indicate descriptions of an action that may be initiated by a user. The ninth data structure 708B may include a plurality of entries, e.g., entries 794A-794I. A first entry 794A may comprise an identifier (e.g., “ACTION”) that identifies the data structure. The second entry 794B may include the identifier (e.g., LONGACTION) for a description of an action that may be initiated by a user. The third through fifth entries 794C-794E may indicate that such description is a string having a length of up to eighty (80) characters, and that in this model, it comprises the string “ASSIGN”. The sixth entry 794F may include the identifier (e.g., SHORTACTION) for a description of an action that may be initiated by a user. The seventh through ninth entries 794G-794I may indicate that such description is a string having a length of up to twenty (20) characters, and that in this model, it comprises the string “SUBMIT”. In the illustrated embodiment, SHORTACION is a short description (i.e., a description that is shorter than a description indicated by LONGACTION), LONGPROM PT is a long description (i.e., a description that is longer than the description indicated by SHORTACTION). In some embodiments, one of the descriptions may be optional to display in a view in the user interface provided by the user device. In some embodiments, the long description is the optional description.

The tenth data structure 709 may be used to identify one or more service from which one or more logos may be retrieved. The tenth data structure 709 may include a plurality of entries, e.g., entries 795A-795B. A first entry 795A may comprise an identifier (e.g., “LOGO”) that identifies the data structure 709. The other entries, e.g., 795B, may identify each of the services from which a logo (e.g., a logo for an entity that provides the model) may be retrieved. In the illustrated embodiment, the entry 795B indicates that a unified resource identifier (URI) for one service is “http://logo.sap.com”. In some embodiments requests sent to “http://logo.sap.com” will be encapsulated in a hypertext transfer protocol (http) message.

In some embodiments, an instance of a model, e.g., model 700, may be used in transferring information to and/or from a user device. In some embodiments, the instance is generated based on the model, e.g., model 700, and data stored in one or more database, e.g., one or more of databases 112-118.

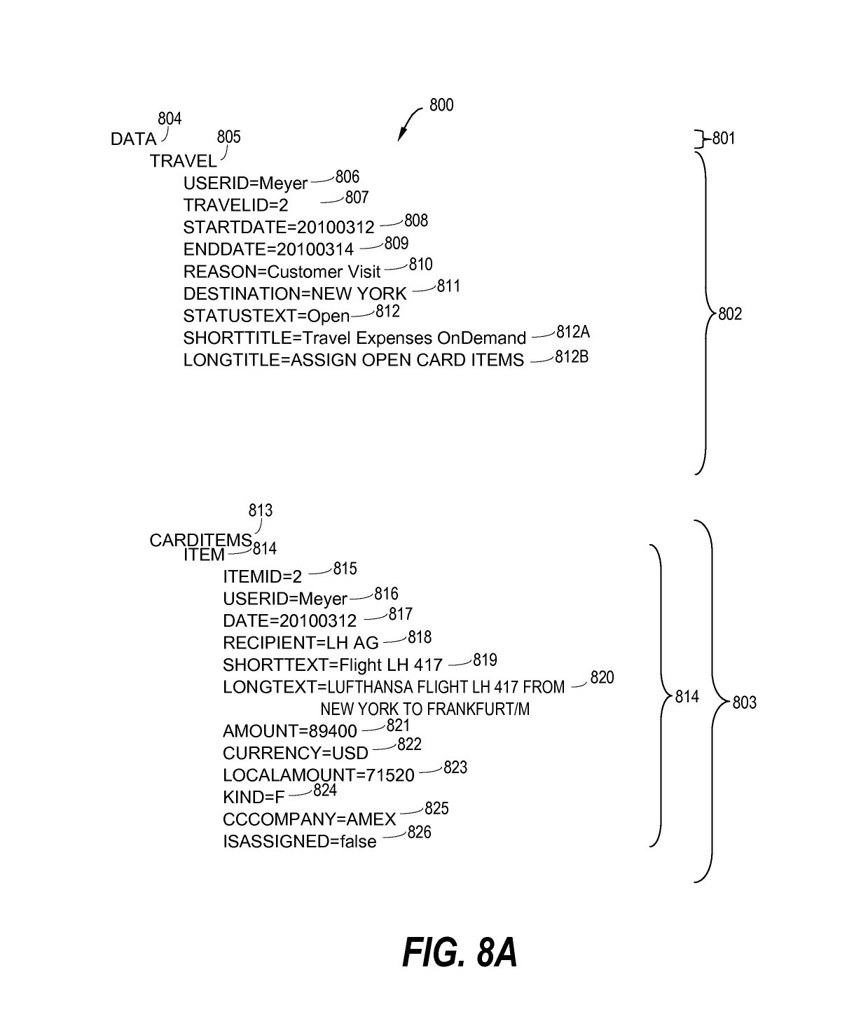

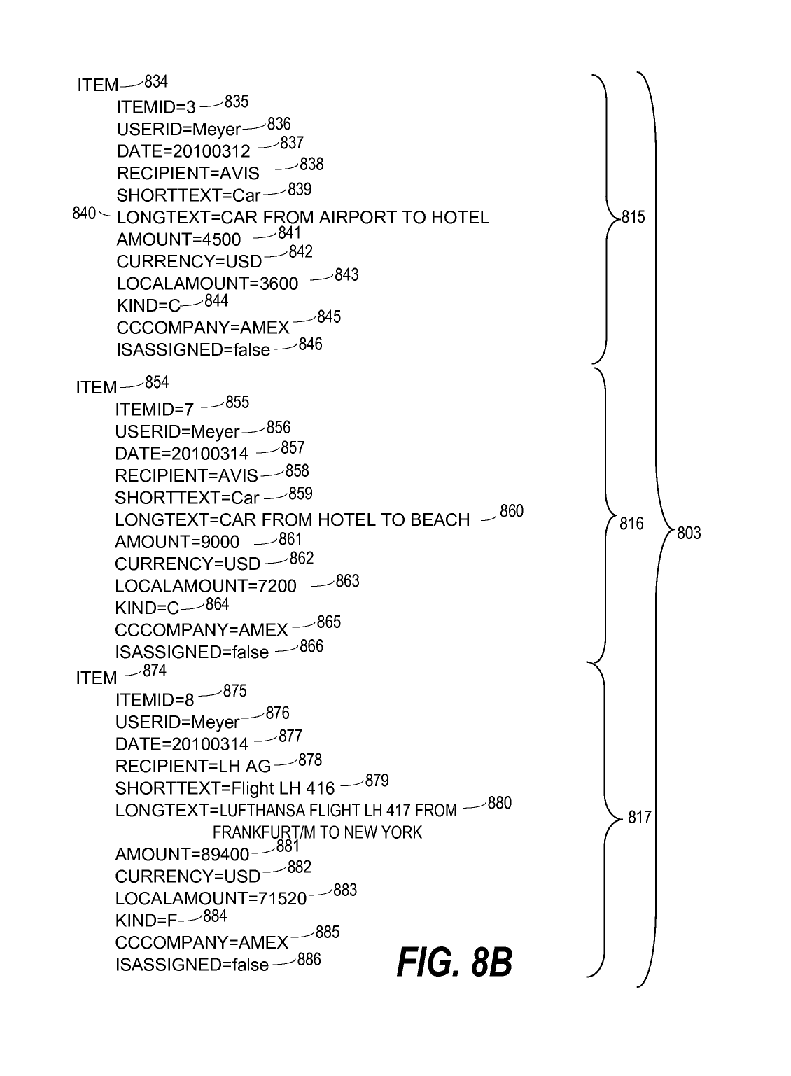

FIGS. 8A-8B are a representation of an instance 800 that may be used in transferring information (sometimes referred to herein as an information set) to and/or from a user device, e.g., one or more of user devices 122-128, 132-138, in accordance with some embodiments. In some embodiments, the instance 800 may be used to provide an employee (e.g., Meyer) with information associated with credit card transactions initiated by that employee and to ask the employee to indicate whether those credit card transactions were associated with a business trip taken by the employee.

Referring to FIGS. 8A-8B, as can be seen, in some embodiments, the instance 800 may include the identifiers defined by the model (e.g., the model 700) and information (e.g., the information from table 300 and table 400) from one or more databases (e.g., one or more of databases 112-118).

In the illustrated embodiment, the instance 800 includes three data structures 801-803. The first data structure 801 may include an entry 804 (e.g., “DATA”) indicating that the instance 800 includes data (i.e., information) from one or more databases.

The second data structure 802 may include a plurality of entries, e.g., entries 805-812. A first entry 805 may comprise an identifier (e.g., “TRAVEL”) that may identify a model (e.g., model 700) upon which the instance is based, at least in part. The other entries 806-812 and 812A-812B include information that may be displayed in a user interface but is not part of the table. In some embodiments, these entries 806-812 and 812A-812B may be used, by a user device, in generating one or more instructions in a user interface. In the illustrated embodiment, the entries 806-812 include information that collectively defines a business trip that has been approved for an employee (e.g., Meyer).

Each of the entries 806-812 and 812A-812B may be associated with one of the types of information that may be provided by the instance. In the illustrated embodiment, each of the entries 806-812 and 812A-812B includes two fields separated by a delimiter (e.g., “=”). One of the fields may include an identifier (e.g., USERID) for the type of information associated with the entry. The other field may include an item (e.g., “Meyer”) for potential display in a view provided by a user interface of a user device.

As stated above, in the illustrated embodiment, the entries 806-812 include information that collectively defines a business trip that has been approved for an employee (e.g., Meyer). The entry “USERID=Meyer” indicates that the USERID assigned to the employee taking the business trip is “Meyer”. The entry “TRAVELID=2” indicates that the TRAVELID assigned to the business trip is “2”. The entry “STARTDATE=20100312” indicates that the business trip started on Mar. 12, 2010. The entry “ENDDATE=20100114” indicates that the end date of the business trip is Mar. 14, 2010. The entry “REASON=Customer Visit” indicates that the business trip is for a customer visit. The entry “DESTINATION=NEW YORK” indicates that the destination of the business trip is New York. The entry “STATUSTEXT=Open” indicates that the business trip has an open status.

In addition, in the illustrated embodiment, the entry “SHORTTITLE=Travel Expenses OnDemand” indicates a short text description of an application. The entry “LONGTITLE=ASSIGN OPEN CARD ITEMS” indicates a long text description of the application.

The third data structure 803 may define information that may be displayed as part of a table in a user interface. The third data structure 803 may include a plurality of entries, e.g., 813-886. A first entry 813 may comprise an identifier (e.g., “CARDITEMS”) that identifies the data structure 803. The other entries 806-812 include information that may be displayed as entries in a table in a user interface. In some embodiments, these entries may be used, by a user device, in generating a table in a user interface.

A first group of such entries, e.g., entries 814-826, may include information that may be displayed as part of a first entry in the table. A second group of the entries, e.g., entries 834-846, may include information that may be displayed as part of a second entry in the table. A third group of the entries, e.g., entries 854-866, may include information that may be displayed as part of a third entry in the table. A fourth group of the entries, e.g., entries 874-886, may include information that may be displayed as part of a fourth entry in the table.

A first entry in each group, i.e., entries 814, 834, 854 874, may comprise an identifier (e.g., ITEM) that indicates a beginning of an entry in the table. Each of the other entries in each group of entries may be associated with one of the types of the information that may be included in the entry of the table. In some embodiments, each of such entries, e.g., 815-826 may include two fields separated by a delimiter (e.g., “=”). One of the fields may define an identifier (e.g., ITEMID) for the type of information associated with the entry. The other field may include the actual information provided by the instance for the type of information associated with the entry.

In the illustrated embodiment, each group of entries collectively define a credit card transaction. For example, the entry “ITEM ID=2” indicates that ITEM ID assigned to a particular credit card transaction is “2”. The entry “USERID=Meyer” indicates that the USERID assigned to the credit card transaction is “Meyer”. The entry “DATE=20100312” indicates that the date of the credit card transaction is Mar. 12, 2010. The entry “RECIPIENT=LH AG” indicates that the LH AG is the recipient of a payment made in settlement of the credit card transaction. The entry “SHORTTEXT=Flight LH 417” indicates a short description of the goods and/or services that were the subject of the credit card transaction. The entry “LONGTEXT=LUFTHANSA FLIGHT LH 417 FROM NEW YORK TO FRANKFURT/M STRING(80)” indicates a long description of the goods and/or services that were the subject of the credit card transaction. The entry “AMOUNT=89400” and the “CURRENCY=CURRENCY” collectively indicate that a monetary amount of the credit card transaction is $894.00 (USD). The entry “LOCALAMOUNT=71520” may indicate an amount in a local currency. The entry “KIND=F” indicates that a classification of the goods and/or services that were the subject of the credit card transaction is “F”. The data structure 704 of the model 700 indicates that the value “F” means “Flight”. The entry “CCCOMPANY=AMEX” indicates that AMEX is the issuer of the credit card used in the credit card transaction. The entry “ISASSIGNED=false” indicates that the credit card transaction has not be assigned to a business trip and/or otherwise closed out.

It should be noted that two or more items may provide descriptions of the same subject (e.g., SHORTTEXT and LONGTEXT). One of the descriptions (e.g., LONGTEXT) of the subject may be longer than the other (e.g., SHORTTEXT). In some embodiments, a user device may be configured to select only of the two or more descriptions for display.

In some embodiments, a user device may be configured to select between the two descriptions based at least in part on the capabilities of the user device. In that regards, in some embodiments, a user device may be configured to select the longer description if a large screen is available to display the information, for example if the user device is a desktop or laptop computer. In some embodiments, a user device may be configured to select the shorter description if a small screen is available to display the information, for example, if the user device is a portable hand held device, e.g., designed to be operated while held in one hand).

In some embodiments, a user device may be configured to select all of a plurality of longer descriptions, e.g., LONGTITLE, LONGPROMPT, LONGACTION and LONGTEXT, see for example, the view of FIG. 5. In some embodiments, a user device may be configured to select all of a plurality of shorter descriptions, e.g., SHORTTITLE, SHORTPROMPT, SHORTACTION and SHORTTEXT, see for example, the view of FIG. 6.

In some embodiments, a model and an instance, e.g., model 700 and instance 800, respectively, may be used, by a user device, in generating view in a user interface. In some embodiments, the model 700 and the instance 800 are used by user devices in generating the view 500 and the view 600 in the user interfaces described above with respect to FIGS. 5 and 6.

In some embodiments, a user supplies information in response to the view in a user interface. In some embodiments, such information may indicate an employee's opinion as to which credit card transactions were associated with a business trip taken by the employee.

In some embodiment, a user device may send a request to submit such information to one or more entities, e.g., one or more of entities 102-108. In some embodiments, the request may have the form of a modified version of the instance.

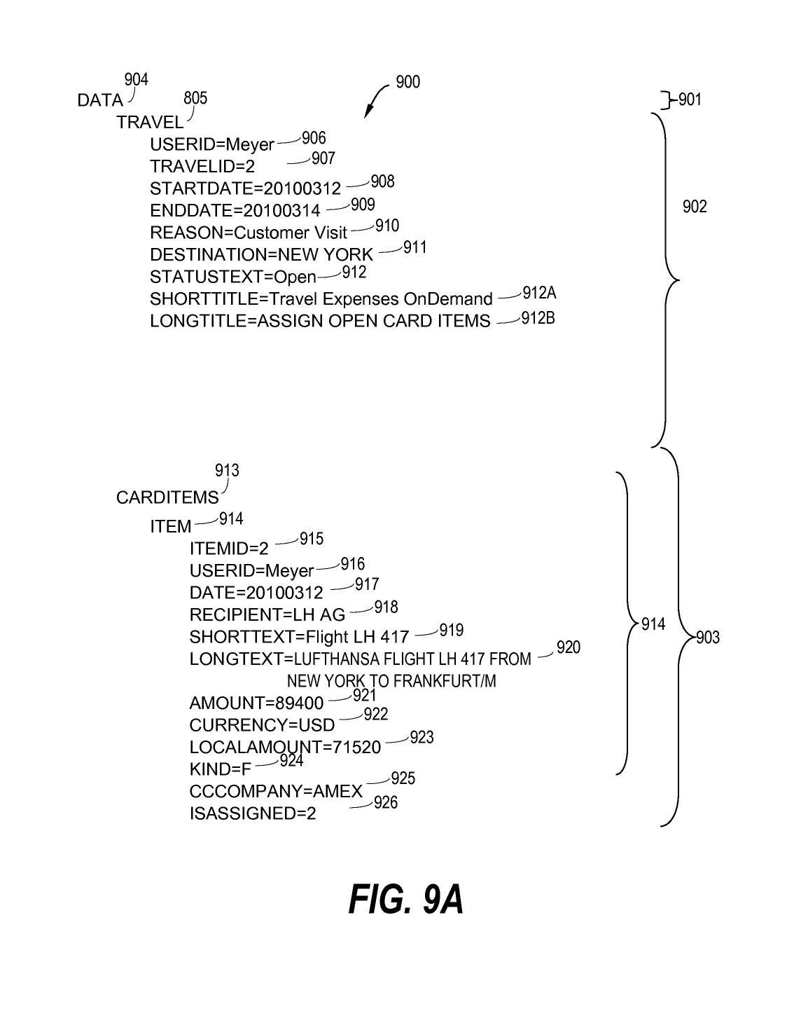

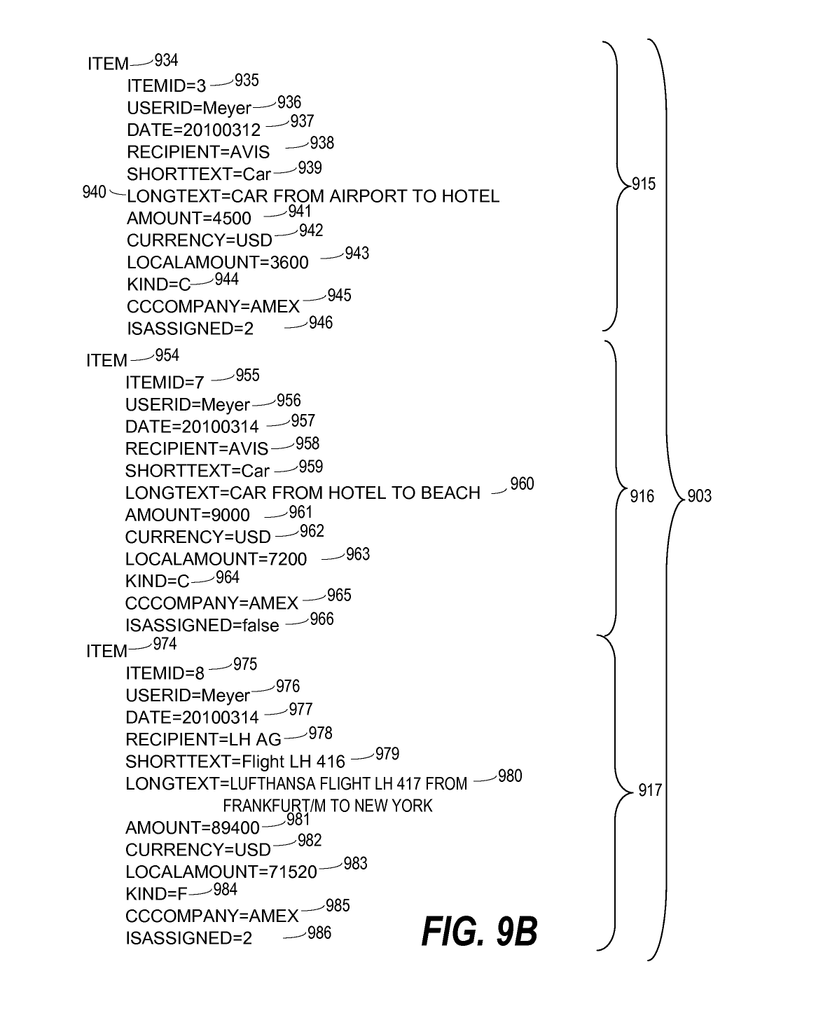

FIGS. 9A-9B are a representation of a modified version of an instance (sometimes referred to herein as a modified instance) 900 that may be used in transferring information from a user device, e.g., one or more of user devices 122-128, 132-138, in accordance with some embodiments. In some embodiments, the modified instance 900 may be used to indicate an employee's opinion as to which credit card transactions were associated with a business trip taken by the employee.

Referring to FIGS. 9A-9B, a modified instance 900 may be used in transferring information from a user device, e.g., one or more of user devices 122-128, 132-138, in accordance with some embodiments. In some embodiments, the modified instance 900 may be used to indicate an employee's opinion as to which credit card transactions were associated with a business trip taken by the employee.

In some embodiments, the user may indicate that the first, second and fourth credit card transactions should be assigned to the business trip taken by the employee. In response, entries 926, 946 and 986 in the modified instance may be change to “ISASSIGNED=2”. In some embodiments, all of the other entries of modified instance 900 may be the same as the corresponding entry of instance 800.

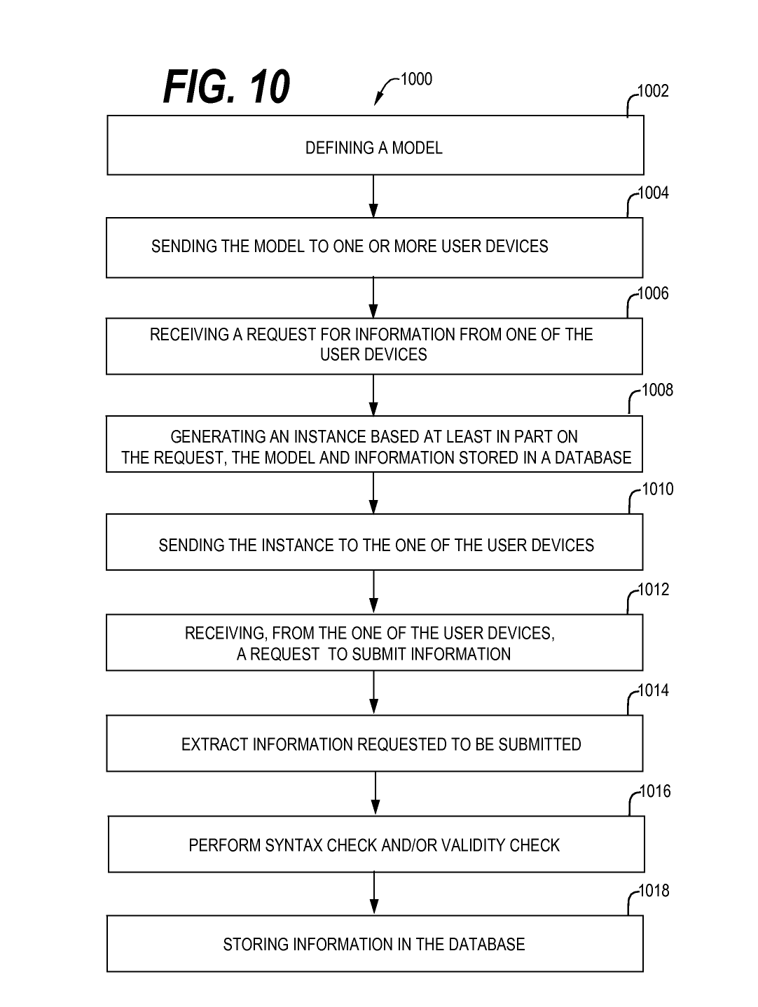

FIG. 10 is a flow chart 1000 of a method according to some embodiments. In some embodiments, one or more portions of the method may be performed in association transferring information between a processing system of an entity, e.g., a processing system of the entity 108, and one or more user devices, e.g., one or more of user devices 132-138. In some embodiments, one or more (i.e., some or all) portions of the method of FIG. 10 is used in the method of FIG. 1B. In some embodiments, one or more portions of the method may be performed by a processing system of the entity, e.g., the processing system of entity 108. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method. Referring to FIG. 10, at 1002, the method may include providing a model.

In some embodiments, the model comprises a model that is the same as and/or similar to the model 700.

At 1004, the method may further include sending the model to one or more user devices. In some embodiments, this may include sending the model to a plurality of user devices, e.g., mobile user devices 132-138. In some embodiments, sending the model comprises sending an email message comprising the model and/or sending an http message comprising the model.

At 1006, the method may further include receiving a request for information from one or more of the user devices. In some embodiments, receiving the request for information comprises receiving an email message comprising the request for information and/or a receiving a hypertext transfer protocol (http) message comprising the request for information.

At 1008, the method may further include generating an instance based at least in part on the request and the model. In some embodiments, this includes selecting a model based at least in part on the request and generating an instance based at least in part on the model and information stored in a database. In some embodiments, the instance comprises an instance that is the same as and/or similar to the instance 900.

At 1010, the method may further include sending the instance to the one of the user devices. In some embodiments, sending the instance comprises sending an email message comprising the instance and/or sending an http message comprising the instance.

At 1012, the method may further include receiving, from the one of the user devices, a request to submit information. In some embodiments, the request to submit information comprises receiving an email message comprising the request to submit information and/or a receiving a hypertext transfer protocol (http) message comprising the request to submit information.

In some embodiments, the request to submit information includes a modified version of the instance wherein the modified version of the instance includes the information that is requested to be submitted.

At 1014, the method may further include extracting the information that is requested to be submitted.

At 1016, the method may further include performing one or more checks on the information that is requested to be submitted. In some embodiments, this may include a syntax check and a validity check. The syntax check may include determining whether the entries in the modified instance comply with the definition for the model, which may include determining whether one, some or all of the entries includes the proper number of fields and whether one, some or all of such fields is in compliance with the definition for that field. For example, if a field is defined as a string having a length of up to twenty (20) characters, a determination may be made as to whether the field in the modified version of the instance is a string having a length of up to twenty (20) characters. The validity check may include one or more checks that were not already performed as part of the syntax check but are desired prior to storing the information in one or more databases within the processing system.

At 1018, the method may further include storing the information in the one or more database.

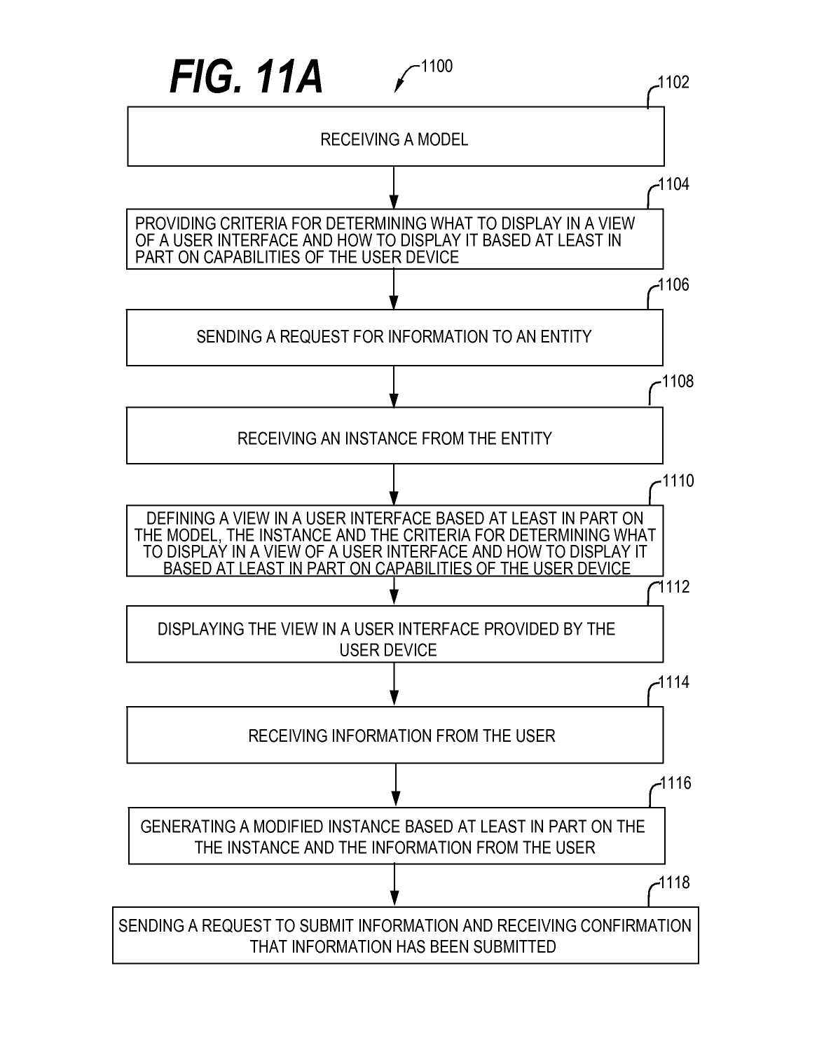

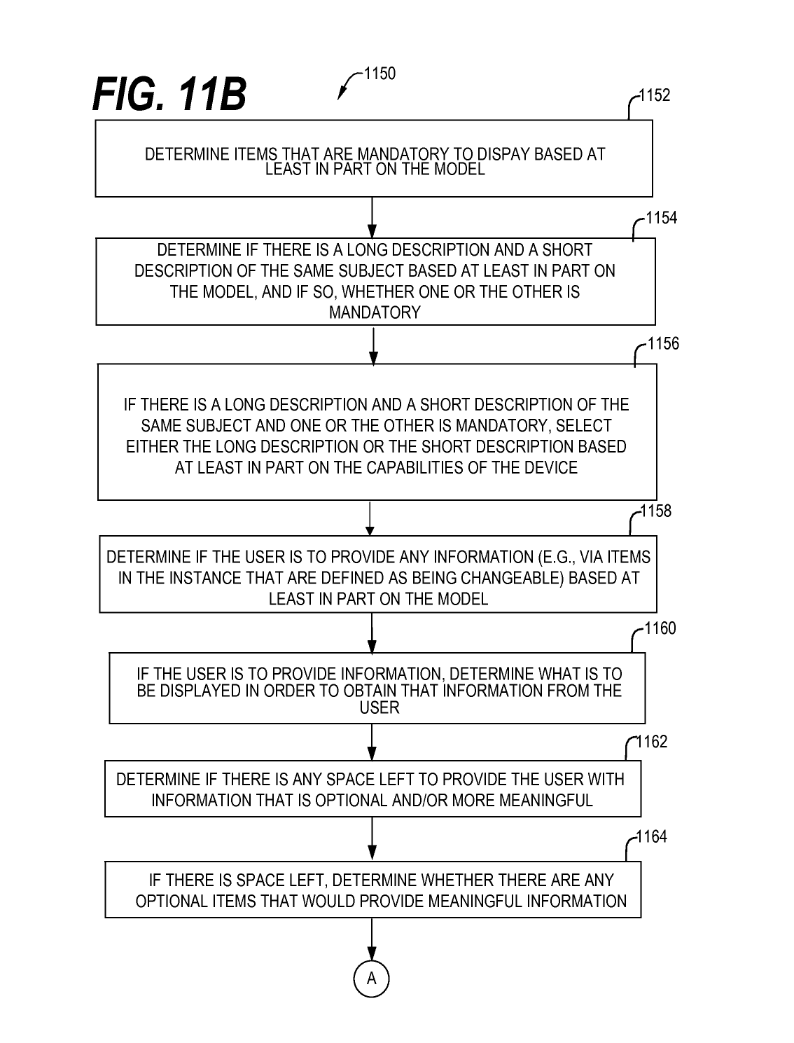

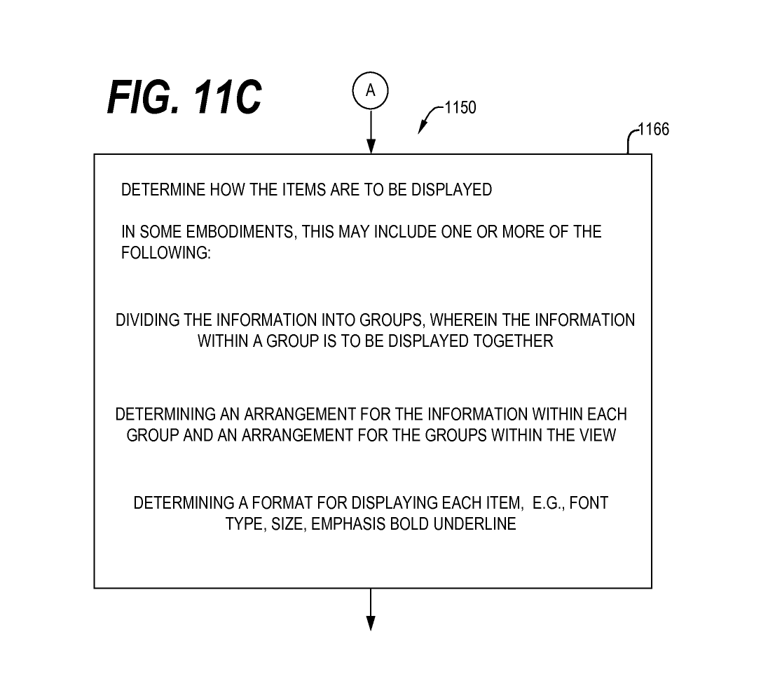

FIG. 11A is a flow chart 1100 of a method according to some embodiments. In some embodiments, one or more (i.e., some or all) portions of the method of FIG. 11A is used in the method of FIG. 1C. In some embodiments, one or more portions of the method may be performed by a user device, e.g., one or more of user devices 122-128, 132-138. In some embodiments, one or more portions of the method may be performed in association with transferring information between a processing system of an entity, e.g., one or more of entities 102-108, and one or more user devices, e.g., one or more of user devices 122-128, 132-138. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method.

Referring to FIG. 11A, at 1102, the method may include receiving a model. In some embodiments, receiving the model comprises receiving an email message comprising the model and/or a receiving a hypertext transfer protocol (http) message comprising the model. In some embodiments, the model comprises a model that is the same as and/or similar to the model 700.

At 1104, the method may further include providing criteria for determining what to display on the user device and how to display it based at least in part on specific capabilities of the user device. In some embodiments, the determination is based at least in part on a look and feel provided by the user device in one or more other application. In some embodiments, the criteria has the form of a mapping. In some embodiments, the mapping is used to determine what to display on the user device and how to display it based at least in part on a model, an instance and on specific capabilities of the user device.

At 1106, the method may further include sending a request for information to one of the entities. In some embodiments, sending the request for information comprises sending an email message comprising the request for information and/or a sending a hypertext transfer protocol (http) message comprising the request for information.

At 1108, the method may further include receiving an instance from the entity. In some embodiments, receiving the instance comprises receiving an email message comprising the instance and/or a receiving a hypertext transfer protocol (http) message comprising the instance. In some embodiments, the instance is based at least in part on the request and the model. In some embodiments, the instance comprises an instance that is the same as and/or similar to the instance 900.

At 1110, the method may further include defining a view in a user interface based at least in part on the model, the instance and the criteria for determining what to display in a view of a user interface for the user device and how to display it based at least in part on specific capabilities of the user device.

At 1112, the method may further include displaying the view in a user interface provided by the user device.

At 1114, the method may further include receiving information supplied by the user. In some embodiments, the user supplies the information in response to information (e.g., a question or other instructions) in the view of the user interface.

At 1116, the method may further include generating a modified version of the instance sent to the user device (sometimes referred to herein as a modified instance) based at least in part on the instance and the information from the user.

In some embodiments, the modified instance comprises a modified instance that is the same as and/or similar to the modified instance 900.

At 1118, the method may further include sending a request to submit information to the entity. In some embodiments, sending a request to submit information to the entity comprises sending the modified instance to the entity. In some embodiments, sending the request to submit information comprises sending an email message comprising the request to submit information and/or a sending a hypertext transfer protocol (http) message comprising the request to submit information.

The method may further include receiving confirmation from the entity that the information has been submitted. In some embodiments, receiving the confirmation comprises receiving an email message comprising the confirmation and/or a receiving a hypertext transfer protocol (http) message comprising the confirmation.

FIGS. 11B-11C is a flow chart 1150 of a method according to some embodiments. In some embodiments, one or more portions of the method may be used in the method of FIG. 11A (e.g., at 1110 in defining a view in a user interface based at least in part on the model, the instance and the criteria for determining what to display in a view of a user interface and how to display it based at least in part on the capabilities of the user device). In some embodiments, one or more portions of the method may be performed by a user device, e.g., one or more of user devices 122-128, 132-138. In some embodiments, one or more portions of the method may be performed in association with transferring information between a processing system of an entity, e.g., one or more of entities 102-108, and one or more user devices, e.g., one or more of user devices 122-128, 132-138. The method is not limited to the order shown in the flow chart. Rather, embodiments of the method may be performed in any order that is practicable. For that matter, unless stated otherwise, any method disclosed herein may be performed in any order that is practicable. Notably, some embodiments may employ one or more portions of the method without one or more other portions of the method.

Referring to FIGS. 11B-11C, at 1152, the method may include determining items that are mandatory to display based at least in part on the model. In some embodiments, mandatory items are selected for display in the view.

At 1154, the method may further include determining if the items include a short description of a subject and a long description of the subject, and if so, whether one or the other is mandatory.

If there is a short description of a subject and a long description of the subject, and one or the other is mandatory, then at 1156, the method may further include selecting either the long description or the short description based at least in part on the capabilities of the device.

In some embodiments, a first one of the items is a first description of a subject and a second one of the items is a second description of the subject, the second description of the subject being longer than the first description of the subject. The user device may be configured to select only one of the first description of the subject and the second description of the subject for display in the view provided by the user interface.

In some embodiments, a user device may be configured to select the longer description if a large screen is available to display the information, for example if the user device is a desktop or laptop computer. In some embodiments, a user device may be configured to select the shorter description if a small screen is available to display the information, for example, if the user device is a portable hand held device, e.g., designed to be operated while held in one hand).

In some embodiments, a user device may be configured to select all of a plurality of longer descriptions, e.g., LONGTITLE, LONGPROMPT, LONGACTION and LONGTEXT, see for example, the view of FIG. 5. In some embodiments, a user device may be configured to select all of a plurality of shorter descriptions, e.g., SHORTTITLE, SHORTPROMPT, SHORTACTION and SHORTTEXT, see for example, the view of FIG. 6.

In some embodiments, the model may indicate that the display of the short description is mandatory and that the display of the long description is optional. If however, the long description is selected, the short description may become unnecessary and may not need to be selected for display.

At 1158, the method may further include determining if the user is to provide any information (e.g., via items in the instance that are defined as being changeable) based at least in part on the model. In some embodiments, changeable items are selected for display in the view.

If the user is to provide information, then at 1160, the method may further include determining what information (e.g., a prompt) is to be displayed in order to prompt the user to provide the information. In some embodiments, the information (e.g., a prompt) is selected for display in the view.

At 1162, the method may further include determining whether there is any space left in the view (e.g., space for items that would be in addition to the items that are mandatory and/or already selected for display in the view) to provide the user with information that is optional and/or more meaningful.

If there is space left in the view, at 1164, the method may further include determining whether there are any optional items that would provide meaningful information. This may include assigning a priority to each of such items and selecting which of such items will be displayed in the view based at least in part on the priority of each and the capabilities of the device. In some embodiments, the priorities may be assigned explicitly and/or implicitly. In some embodiments, the priorities may not be assigned explicitly but rather may be assigned implicitly by an order in which the items are considered for addition to the view.

At 1166, the method may further include determining how each of the selected items are to be displayed in the view.

In some embodiments, some items may belong together and/or are preferably displayed together. Thus, in some embodiments, 1166 may include dividing the items into groups, wherein the items within a group is to be displayed together. In some embodiments, it may further include determining an arrangement for the items within each group and/or an arrangement for the groups within the view.

In some embodiments, 1166 may include determining a format for displaying each item (e.g., font type, size, emphasis (e.g., bold, underline). In some embodiments, the same format may be used for all items. In some other embodiments a format for one or more items may be different than the format for one or more other items. In some embodiments, a format for displaying an item may be a format for displaying an item in a form of a date (i.e., a form that a user will recognize as a date). In some embodiments, a format for one or more items (e.g., a group of items) may include a border (e.g., a frame around such one or more items).

The method may further include defining a view that includes all of the selected items and the formatting determined for each of the items.

In some embodiments, a single mapping in the user device may be used to receive and define a plurality of views based on information from a plurality of processing systems 112A-118A, respectively, operated by, and/or on behalf of, a plurality of entities, e.g., entities 102-108, respectively. In some embodiments, the views may be different types of views, and the processing systems may be different types of processing systems operated by, and/or on behalf of, different types of entities. In some embodiments, a single mapping may be used in connection with reserving and/or ordering products and/or services provided by an entity (e.g., reserving a hotel room provided by a hotel and/or ordering an item from a menu of items provided by a restaurant), reviewing and/or updating orders for products and/or services provided by an entity.

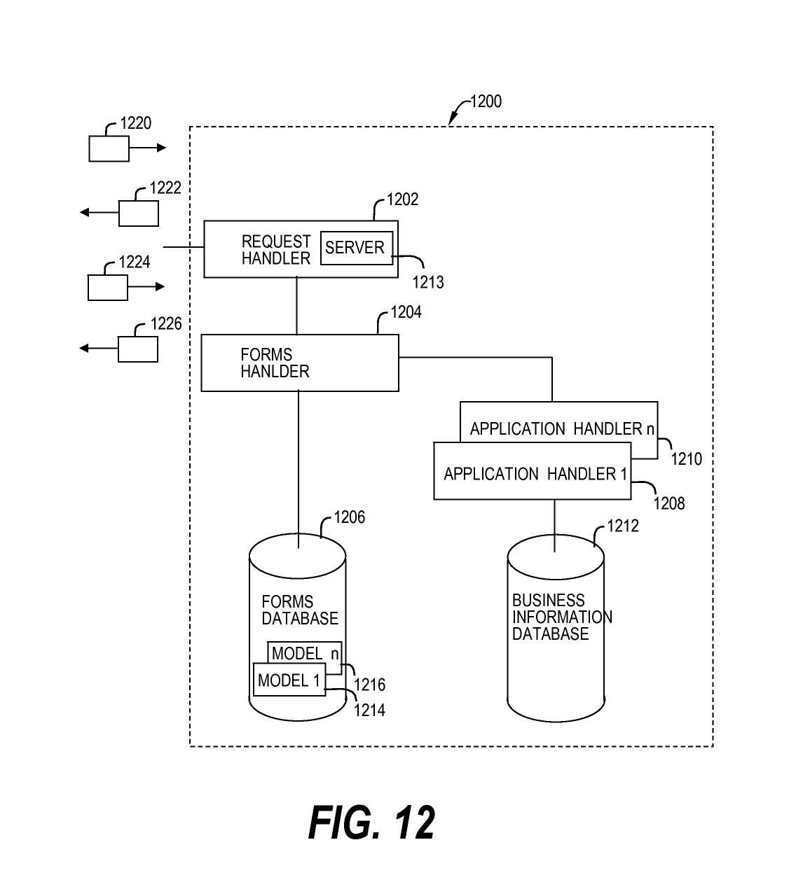

FIG. 12 is a block diagram of a portion of a processing system 1200, in accordance with some embodiments. In some embodiments, one or more portions of the processing system 1200 may be used in one or more processing systems, e.g., one or more of the processing systems 112A-118A, operated by, and/or on behalf of, one or more entities, operated e.g., entities 102-108, respectively. In some embodiments, one or more portions of the processing system may be used in association with transferring information to and/or from one or more user devices, e.g., one or more of user devices 132-138. In some embodiments, one or more portions of the processing system 1200 may perform one or more portions of the method 1000 of FIG. 10.

Referring to FIG. 12, the processing system 1200 may include a request handler 1202, a forms handler 1204, a forms database 1206, one or more application handlers 1208-1210 and a business information database 1212.

In some embodiments, the request handler 1202 includes an http and/or email handler to receive and/or send http and/or email messages. In some embodiments, the request handler 1202 comprises a server 1213 that may be coupled to and respond to requests from one or more user and/or client devices via one or more communication links, e.g., one or more of communication links 140A-140D.

In some embodiments, the forms handler 1204 comprises a forms runtime program executed by the processing system 1200.

In some embodiments, a different application handler is provided for each type of application for which it may be desired to transfer information to and/or from one or more user devices, e.g., one or more of user devices 122-128, 132-138. Thus, in some embodiments, each of the plurality of application handlers 1208-1210 is associated with a different type of application for which it may be desired to transfer information to and/or from one or more user devices, e.g., one or more of user devices 122-128, 132-138.

The model database 1206 may include a plurality of models 1214-1216. In some embodiments, each of the plurality of models 1214-1216 may be associated with a different type of application for which it may be desired to transfer information to and/or from one or more user devices. In some embodiments, one or more of the plurality of models comprises a model that is the same as and/or similar to the model 700.

In some embodiments, the application handlers 1208-1210, the business information database 1212 and/or one or more other parts of the processing system 1200 may be part of a backend of the processing system.

The operation of the processing system 1200 may be as follows. The request handler 1202 may receive a request (e.g., 1220) for information from a user device, e.g., one of user devices 122-128, 132-138. If the request is encapsulated, e.g., in an email message and/or in a hypertext transfer protocol (http) message, the request handler 1202 may decapsulate the request from such message. Thereafter, the request handler 1202 may call, and/or otherwise invoke, the forms handler 1204.

The forms handler 1204 may receive the request and if the processing system 1200 includes more than one application handler, the forms handler 1204 may determine one of the application handlers to receive the request. In addition, if the processing system 1200 includes more than one model, the forms handler 1204 may determine which of the models to use in responding to the request. In some embodiments, the forms handler 1204 may make this determination by determining the type of application that is associated with the request and thereafter selecting an application handler and/or model that is associated with such type of application. For example, if the request is a request to close out credit card transactions initiated by an employee, the forms handler 1204 may select the application handler and the model that are associated with closing out credit card transactions. In some the model is the same as and/or similar to the model 700.

The forms handler 1204 may thereafter retrieve the determined model, e.g., one of models 1214-1216, and may call, and/or otherwise invoke, the determined application handler, e.g., one of application handlers 1208-1210.

The invoked application handler may receive the request and may retrieve information from the business information database 1212 in response at least thereto. If the request is a request to close out credit card transactions initiated by an employee, the retrieved information may include information describing credit card transactions initiated by that employee and information describing a business trip that has been approved for the employee. In some embodiments, such information may be the same as and/or similar to the information included in tables 200-300, respectively.

In some embodiments, a single application handler may receive requests from, and supply information to, various types of user devices. In some embodiments, the application handler need not know the types of user devices that are requesting information, as the same information may be provided to each type of user devices. The information supplied to the user devices may thus be independent of the device type of the user device.

Thereafter, a response to the request may be generated. In some embodiments, the response comprises an instance that is generated based at least in part on the model retrieved by the forms handler 1204 and the information retrieved by the application handler. If the request is a request to close out credit card transactions initiated by an employee, the instance may be the same as and/or similar to the instance 800. In some embodiments, the instance may be generated by the forms handler 1204. In some other embodiments, the instance may be generated by the application handler.

The processing system 1200 may thereafter send the response (e.g., 1222) to the user device. In some embodiments, the response is encapsulated before it is sent, e.g., in an email message and/or in a hypertext transfer protocol (http) message.

The model may also be sent to the user device. In some embodiments, the model and the instance may be sent as a single response. In some other embodiments, the model may be sent before or after sending the instance.

After the user device displays one or more portions of the information sent thereto, the user may supply information to the user device and the processing system may receive a request from the user device to submit the information to the processing system.

If the request is encapsulated, e.g., in an email message and/or in a hypertext transfer protocol (http) message, the request handler 1202 may decapsulate the request from such message. Thereafter, the request handler 1202 may call, and/or otherwise invoke, the forms handler 1204.

The forms handler 1204 may receive the request. In some embodiments, the request includes information to close out one or more credit card transactions initiated by an employee. In some embodiments, the request to submit information has the form of a modified version of the instance that was sent to the user device. In some embodiments, the modified version of the instance may be the same as and/or similar to the modified version of the instance 900.

If the processing system 1200 includes more than one application handler, the forms handler 1204 may determine one of the application handlers to receive the request. In addition, if the processing system 1200 includes more than one model, the forms handler 1204 may determine which of the models to use in responding to the request. For example, if the request is a request to close out credit card transactions initiated by an employee, the forms handler 1204 may select the application handler and the model that are associated with closing out credit card transactions. In some embodiments, the model may be the same as and/or similar to the model 700.

In some embodiments, the forms handler 1204 may thereafter perform a syntax check on the information in the request. If the request is in the form of a modified version of the instance sent to the user device, the syntax check may include determining whether the entries in the modified instance comply with the definition for the model. In some embodiments, this may include e determining whether one, some or all of the entries includes the proper number of fields and whether one, some or all of such fields is in compliance with the definition for that field. For example, if a field is defined as a string having a length of up to twenty (20) characters, a determination may be made as to whether the field in the modified version of the instance is a string having a length of up to twenty (20) characters.

In some embodiments, the forms handler may not call, and/or otherwise invoke, the determined application handler unless the request passes the syntax check.

If the forms handler 1204 calls, and/or otherwise invokes, the determined application handler, e.g., one of application handlers 1208-1210, the invoked application handler may receive the request and may perform a validity check on the information in the request. The validity check may include one or more checks that were not already performed as part of the syntax check but may be desired prior to storing the information (or portion(s) thereof) in one or more databases within the processing system 1200.

If the information in the request passes the validity check, the application handler may store the information in the business information database 1212.

The processing system may thereafter send a confirmation (e.g., confirmation 1226) to the user device confirming that the information in the request has been stored.

Some embodiments may employ one or more portions of the processing system 1200 without one or more other portions of the system. For that matter, and unless stated otherwise, some embodiments may employ one or more portions of any system and/or device disclosed herein without one or more other portions of such system and/or device.

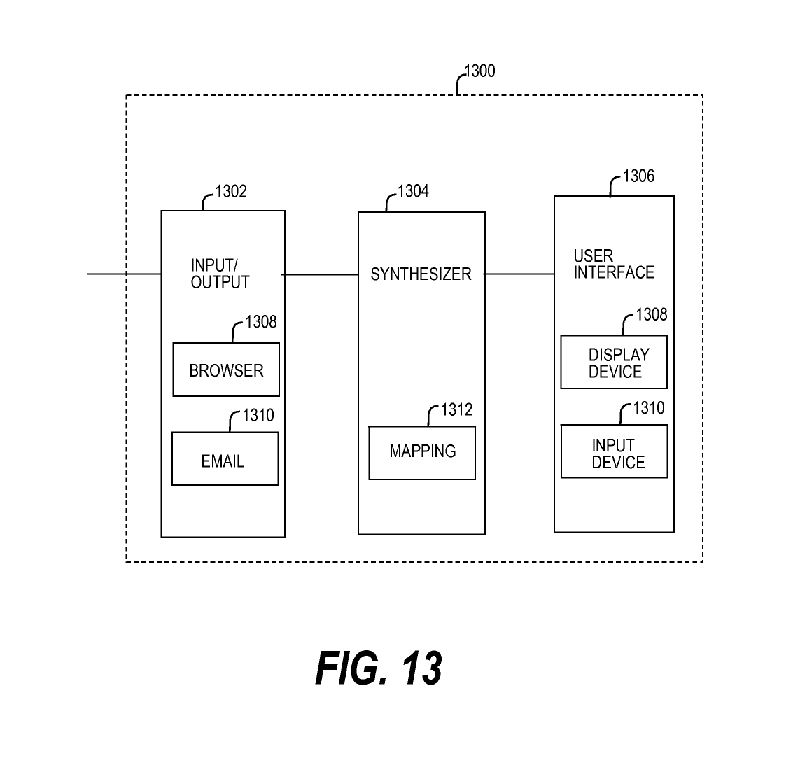

FIG. 13 is a block diagram of a portion of a user device 1300, in accordance with some embodiments. In some embodiments, one or more portions of the user device may be used in one or more user devices, e.g., one or more of user devices 122-128, 132-138. In some embodiments, one or more portions of the user device 1300 may be used in association with transferring information to and/or from one or more entities, e.g., one or more of entities 102-108. In some embodiments, one or more portions of the user device 1300 may perform one, some or all of the method 1100 of FIG. 11A.

Referring to FIG. 13, the user device 1300 may include an input/output portion 1302, a synthesizer 1304 and a user interface 1306. In some embodiments, the input/output portion 1302 comprises a web browser program 1308 and/or an email program 1310 executing on the user device 1300. In some embodiments, such web browser program 1308 and/or email program 1310 may include a client program that communicates with a request handler 1202 and/or a remote server 1216 in a processing system, e.g., processing system 1200.

The synthesizer 1304 may comprise a mapping 1312 that may determine and/or may be used to determine what to display on the display device and/or how to display it. In some embodiments, this determination is based at least in part on a model, an instance and the specific capabilities of the user device 1300.

Unless stated otherwise, a mapping may have any form, for example, but not limited to, a look-up table, a rule base, hardwired logic, fuzzy logic, neural networks, and/or any combination thereof, and may be embodied in software, hardware, firmware or any combination thereof. In some embodiments, the mapping is generated manually, automatically or by a combination thereof.

In some embodiments, the synthesizer 1304 may be capable of receiving a model and an instance from a plurality of types of applications for which it may be desired to transfer information to and/or from the user device 1300. In some other embodiments, the user device 1300 may include a plurality of user synthesizers, each being associated with a different type of application for which it may be desired to transfer information to and/or from the user device 1300.

The user interface 1306 includes a display device 1308 and an input device 1310. In some embodiments, the display device 1308 and the input device 1310 may comprise any type of display device and input device, respectively. Although shown as separate devices, in some embodiments, the display device and the input device may be integrated into a single device.

The operation of the user device 1300 may be as follows. The input/output portion 1302 may send a request for information (e.g., request 1220) to a processing system of an entity, e.g., one or more of entities 102-108. In some embodiments, the input/output portion 1302 encapsulates the request in an email message and/or in a hypertext transfer protocol (http) message. In some embodiments, the request comprises a request to close out credit card transactions initiated by an employee.

The input/output portion 1302 may thereafter receive a response (e.g., 1222) to the request. In some embodiments, the response is in the form of an email message and/or a hypertext transfer protocol (http) message.

If the request was a request to close out credit card transactions initiated by an employee, the response may include information describing credit card transactions initiated by that employee and a business trip that has been approved for the employee. In some embodiments, the response comprises a model and/or an instance. In some embodiments, the model and instance may be the same as and/or similar to the model 700 and the instance 800, respectively.

The response may be provided to the synthesizer 1304, which may define a view in a graphical user interface, based at least in part on the model, the instance and the capabilities of the user device 1300. In some embodiments, the synthesizer 1304 uses the mapping 1312 to generate the definition of the view in the graphical user interface.

As stated above, in some embodiments, the mapping 1312 may determine, and/or may be used to determine, what to display and/or how to display it. In some embodiments, this determination is based at least in part on a model, an instance and the specific capabilities of the user device 1300.

In some embodiments, the mapping may define how amounts, dates, and/or any other type of data is to be displayed. For example, in some embodiments, the mapping may specify that amounts are truncated or rounded to a nearest whole number.

In some embodiments, the mapping may also determine the instructions that are to be displayed. In some embodiments, for example, the mapping may determine that the model is associated with a view for displaying information that is associated with credit card transactions initiated by an employee and asking the employee whether those credit card transactions were associated with a business trip taken by the employee. The mapping may thereafter generate one or more instructions to be displayed based at least in part thereon and the capabilities of the user interface of the user device.

In some embodiments, the mapping may select all of the items for display if the capabilities of the user interface allow all of the items to be displayed in a single view. In some other embodiments, the mapping may select fewer than all of the items for display, for example, where the capabilities of the user interface do not allow all of the items to be displayed in a single view and/or where the mapping determines that some of the items are redundant.

In some embodiments, the model may indicate items for which display is optional. In some embodiments, the mapping may be configured to select all non optional items for display.

In some embodiments, selecting a particular item for display may make another item unnecessary, even if it is not identified as optional. In some embodiments, for example, the information may include a short description of a subject and a long description of the subject. The model may indicate that the display of the long description is optional and/or that the display of the short description is not optional. If however, the long description is selected, the mapping may determine that the short description becomes unnecessary and may not select it for display.

In some embodiments, a plurality of mappings may be provided and the synthesizer may determine a mapping to be used based at least in part on one or more portions of the information in the instance. In some embodiments the processor determines the mapping based on the name of the model and/or the view with which the model is associated.

The definition of the view may be supplied to the user interface 1306 which may thereafter display the view on the display device 1308.

The synthesizer 1304 may thereafter receive information from the user. In some embodiments, the user supplies such information in response to a question in the view.

The user device may thereafter send a request to submit the information received from the user. In some embodiments, the request is in the form of a modified version of the instance sent to the user device. In some embodiments, the modified version of the instance is based at least in part on the instance and the information from the user. In some embodiments, the modified version of the instance is the same as and/or similar to the modified version of the instance 900. In some embodiments, the request is encapsulated in an email message and/or a hypertext transfer protocol (http) message.

The user device 1300 may thereafter receive a message confirming that the information in the request has been submitted and/or stored in the processing system. In some embodiments, the confirmation comprises an email message comprising the confirmation and/or a hypertext transfer protocol (http) message comprising the confirmation.

Some embodiments may employ one or more portions of the user device 1300 without one or more other portions of the user device 1300.

In some embodiments, one or more portions of the method may be performed by a processor executing an application program in the user device. In some embodiments, such application program may have been provided to a server and downloaded to the user device. In some embodiments, the server may be part of an on-line application store such as for example APP STORE™, ANDROID MARKET™, WINDOWS MARKETPLACE FOR MOBILE™, PALM CATALOG™, and/or BLACKBERRY APP WORLD™. In some embodiments, an application residing on a user device may be individually and specifically developed for that user device. In some embodiments, this may help in making use of the full capacity of a given mobile development platform.

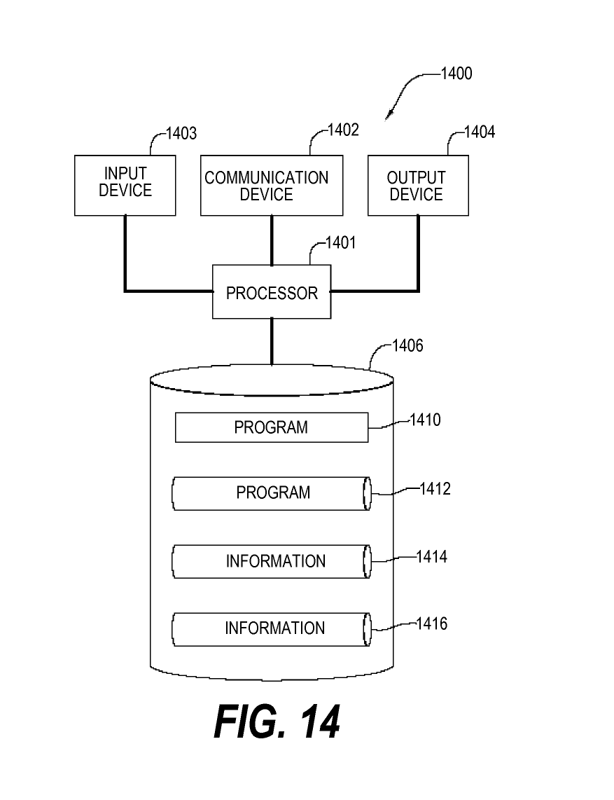

FIG. 14 is a block diagram of an architecture 1400 according to some embodiments. In some embodiments, one or more of the systems (or portion(s) thereof) disclosed herein, one or more apparatus (or portion(s) thereof) disclosed herein and/or one or more devices (or portion(s) thereof) disclosed herein may have an architecture that is the same as and/or similar to the architecture 1400 (or portion(s) thereof). In some embodiments, one or more of the methods (or portion(s) thereof) disclosed herein may be performed by systems, apparatus and/or devices having an architecture that is the same as and/or similar to the architecture 1400 (or portion(s) thereof).

Referring to FIG. 14, in accordance with some embodiments, the architecture 1400 includes a processor 1401 coupled to a communication device 1402, an input device 1403, an output device 1404 and a storage device 1406.

In some embodiments, the processor 1401 may execute processor-executable program code to provide or otherwise result in one or more portions of one or more functions and/or one or more portions of one or more methods disclosed herein. In some embodiments, the processor 1401 may comprise one or more INTEL® Pentium® processors.

The communication device 1402 may be used to facilitate communication with other devices and/or systems. In some embodiments, communication device 1402 may comprise an Ethernet and/or other type of connection to a network and/or resource and through which apparatus 1400 may receive and/or transmit information.

The input device 1403 may be used to input information. In some embodiments, the input device 1403 may comprise a keyboard, a keypad, a track ball, a touchpad, a mouse or other pointing device, a microphone, a knob or a switch, an infra-red (IR) port and/or a computer media reader.

The output device 1404 may be used to output information. In some embodiments, the output device 1404 may comprise an IR port, a docking station, a display, a speaker and/or a printer.

The storage device 1406 may store one or more programs 1410-1412 and/or other information for operation of the architecture 1400. In some embodiments, the one or more programs and/or other information may include one or more operating systems, one or more database management systems and/or other applications for operation of the architecture 1400. In some embodiments, the one or more programs 1410-1412 may include one or more instructions to be executed by the processor 1401 to provide one or more portions of one or more functions and/or one or more portions of one or more methods disclosed herein. In some embodiments, the one or more programs and/or other information may include one or more databases 1414-1416.

In some embodiments, the storage device 906 may comprise one or more storage devices, such as, for example, magnetic storage devices (e.g., magnetic tape and/or hard disk drives), optical storage devices, and/or semiconductor memory devices such as Random Access Memory (RAM) devices and Read Only Memory (ROM) devices.

In some embodiments, one or more portions of one or more embodiments disclosed herein may be embodied in a system, a method, an apparatus and/or a computer-readable storage medium.

In some embodiments, one or more (i.e., some or all) portions of any embodiment disclosed herein may be performed by a processor.

In some embodiments, one or more portions of any embodiment disclosed herein may result from a processor executing instructions.

In some embodiments, a computer-readable storage medium may store thereon instructions that when executed by a processor result in performance of one or more portions of one or more embodiments disclosed herein.

A computer-readable storage medium may store thereon instructions that when executed by a processor (or multiple processors) result in performance of a process according to any of the embodiments described herein.

In some embodiments, some or all portions of the information described in herein may be stored in one or more storage devices.

In some embodiments, a standardized description language such as for example, SGML (Standard Generalized Markup Language) is used to describe an object as a model or an instance. The Standard Generalized Markup Language (ISO 8879:1986 SGML) is an ISO-standard technology for defining generalized markup languages for documents. A markup language is a modern system for annotating a text in a way that is syntactically distinguishable from that text. The idea and terminology evolved from the “marking up” of manuscripts, i.e. the revision instructions by editors, traditionally written with a blue pencil on authors' manuscripts. Examples are typesetting instructions such as those found in troff and LaTeX, and structural markers such as XML tags. Markup is typically omitted from the version of the text which is displayed for end-user consumption. Some markup languages, like HTML have presentation semantics, meaning their specification prescribes how the structured data is to be presented, but other markup languages, like XML, have no predefined semantics. Generalized markup is based on two novel postulates: (1) markup should describe a document's structure and other attributes, rather than specify the processing to be performed on it, as descriptive markup need be done only once, and will suffice for future processing, and (2) markup should be rigorous so that the techniques available for processing rigorously-defined objects like programs and data bases, can be used for processing documents as well.

In some embodiments, the definition of a generic communication channel, a model, an instance and data schema as well as the processing capability are provided in the processing system (sometimes referred to herein as a backend side) rather than a client device. In some embodiments, a connection between a user device and a processing system of an entity may employ a service-oriented architecture (SOA) model. In computing, a service-oriented architecture (SOA) is a flexible set of design principles used during the phases of systems development and integration. A deployed SOA-based architecture will provide a loosely-integrated suite of services that can be used within multiple business domains. SOA also generally provides a way for consumers of services, such as web-based applications, to be aware of available SOA-based services. For example, several disparate departments within a company may develop and deploy SOA services in different implementation languages; their respective clients will benefit from a well understood, well defined interface to access them. XML is commonly used for interfacing with SOA services, though this is not required. SOA defines how to integrate widely disparate applications for a world that is Web based and uses multiple implementation platforms. SOA defines the interface in terms of protocols and functionality. Service-orientation requires loose coupling of services with operating systems, and other technologies that underlie applications. SOA separates functions into distinct services, which developers make accessible over a network in order to allow users to combine and reuse them in the production of applications. These services and their corresponding consumers communicate with each other by passing data in a well-defined, shared environment. With respect to the SOA architecture a mobile device on one side can be regarded as an independent service consumer connecting to a service provider provided via the internet.

In some embodiments, Hypertext Transfer Protocol (HTTP) protocol may be employed. A standard way of communication in the internet is via http and an URL. HTTP is a request-response standard typical of client-server computing. HTTP is an Application Layer protocol for distributed, collaborative, hypermedia information systems. In HTTP, web browsers or spiders typically act as clients, while an application running on the computer hosting the web site acts as a server. The client, which submits HTTP requests, is also referred to as the user agent. The responding server, which stores or creates resources such as HTML files and images, may be called the origin server. In between the user agent and origin server may be several intermediaries, such as proxies, gateways, and tunnels. HTTP is not constrained in principle to using TCP/IP, although this is its most popular implementation platform. Indeed HTTP can be “implemented on top of any other protocol on the Internet, or on other networks.” HTTP only presumes a reliable transport; any protocol that provides such guarantees can be used. Resources to be accessed by HTTP are identified using Uniform Resource Identifiers (URIs)—or, more specifically, Uniform Resource Locators (URLs)—using the http or https URI schemes.

Some embodiments may employ one, some or all aspects of the REST architecture. The Representational State Transfer (REST) architectural style was developed in parallel with the HTTP/1.1 protocol. REST-style architectures consist of clients and servers. Clients initiate requests to servers; servers process requests and return appropriate responses. Requests and responses are built around the transfer of “representations” of “resources”. A resource can be essentially any coherent and meaningful concept that may be addressed. A representation of a resource is typically a document that captures the current or intended state of a resource. At any particular time, a client can either be transitioning between application states or “at rest”. A client in a rest state is able to interact with its user, but creates no load and consumes no per-client storage on the set of servers or on the network. The client begins sending requests when it is ready to transition to a new state. While one or more requests are outstanding, the client is considered to be transitioning states. The representation of each application state contains links that may be used next time the client chooses to initiate a new state transition. Although REST was initially described in the context of HTTP, it is not limited to that protocol. RESTful architectures can be based on other Application Layer protocols if they already provide a rich and uniform vocabulary for applications based on the transfer of meaningful representational state. RESTful applications maximize the use of the pre-existing, well-defined interface and other built-in capabilities provided by the chosen network protocol, and minimize the addition of new application-specific features on top of it.

In some embodiments, a model/instance approach may be combined with a service-oriented architecture, which may make it possible to establish a cost-saving development of backend services on one side and mobile platform specific applications with attractive user interfaces providing the usual look and feel specific for these platforms. In some embodiments, a model definition is used by a user interface designer to create a user interface with the best support for filling or viewing the required data. In some embodiments, the same data schema may be used for implementing application programs in the user device in processing and instance and/or information received from a processing system In some embodiments, a model may be used to offer one or more of the following types of information: (1) whether a field is mandatory (e.g., not optional) or not mandatory (e.g., optional) to display, type of field, selection group, sub group etc. In some embodiments, a model is used to manage information and notify observers when that information changes. The model is the domain-specific representation of the data upon which the application operates. Domain logic adds meaning to raw data (for example, calculating whether today is the user's birthday, or the totals, taxes, and shipping charges for shopping cart items). When a model changes its state, it notifies its associated views so they can be refreshed. In some embodiments, the instance is used to submit the data to and from the backend or to display/capture the data on the device. The backend doesn't need any information about the used frontend technology. The backend can use a data schema to check the instance for syntactical correctness, reducing the amount of code for processing the instance data significantly.

In some embodiments, a model and/or an instance may have one or more characteristics that are similar to one or more characteristics of a model-view-controller (MVC) architectural pattern, which isolates “domain logic” (the application logic for the user) from input and presentation (GUI), permitting independent development, testing and maintenance of each. MVC is often seen in web applications where the view is the HTML or XHTML generated by the app. The controller receives GET or POST input and decides what to do with it, handing over to domain objects (i.e. the model) that contain the business rules and know how to carry out specific tasks such as processing a new subscription. In some embodiments, an MVC application may be a collection of model/view/controller triplets, each responsible for a different UI element. Many applications use a persistent storage mechanism such as a database to store data. MVC does not specifically mention the data access layer because it is understood to be underneath or encapsulated by the model. Models are not data access objects; however, in very simple apps that have little domain logic there is no real distinction to be made. In some embodiments, the data access layer is implemented within a processing system (which may comprise a controller residing on a backend or service provider). The view renders the model into a form suitable for interaction, typically a user interface element. Multiple views can exist for a single model for different purposes. A viewport typically has a one to one correspondence with a display surface and knows how to render to it. In some embodiments, a view or user agent is implemented on the mobile device and interacts with the model. It reads the model and instance data and sends the user input back to the specified URI. The controller receives input and initiates a response by making calls on model objects. A controller accepts input from the user and instructs the model and viewport to perform actions based on that input.

In some embodiments, the controller receives an XML document, containing the model, instance data and data schema. The controller checks and extracts the data, performs the business logic and updates the data base if needed. The view is a native mobile device application. The controller intermediates between model and view within the request-response-cycle: View->HTTP-Request->Webserver->Controller->Model->Controller->Webserver->HTTP-Response->View. An alternative implementation of the View would be a browser displaying HTML or XHTML documents.

In some embodiments, one or more models and/or instances are defined using an (eXtensible Markup Language) XML. The W3C XML is a profile (subset) of SGML designed to ease the implementation of the parser compared to a full SGML parser, primarily for use on the World Wide Web. XML currently is more widely used than full SGML. XML has lightweight internationalization based on Unicode. Applications of XML include XHTML, SVG, RSS, Atom, XML-RPC, Semantic Web, and SOAP. XML (Extensible Markup Language) is a meta markup language that is now widely used. XML was developed by the World Wide Web Consortium, in a committee created and chaired by Jon Bosak. The main purpose of XML was to simplify SGML by focusing on a particular problem—documents on the Internet. XML remains a meta-language like SGML, allowing users to create any tags needed (hence “extensible”) and then describing those tags and their permitted uses. XML adoption was helped because every XML document can be written in such a way that it is also an SGML document, and existing SGML users and software could switch to XML fairly easily. However, XML eliminated many of the more complex and human-oriented features of SGML to simplify implementation environments such as documents and publications. However, it appeared to strike a happy medium between simplicity and flexibility, and was rapidly adopted for many other uses. XML is now widely used for communicating data between applications. Like HTML, it can be described as a ‘container’ language.

In some embodiments, providing the same user interface on different devices requires a universal data schema definition as well as a device independent layout description. In some embodiments, XML provides a suitable description language, especially the XForms standard definition. XForms is an XML format for the specification of a data processing model for XML data and user interface(s) for the XML data, such as web forms. XForms was designed to be the next generation of HTML/XHTML forms, but is generic enough that it can also be used in a standalone manner or with presentation languages other than XHTML to describe a user interface and a set of common data manipulation tasks. XForms 1.0 (Third Edition) was published on 29 Oct. 2007. The original XForms specification was made an official W3C Recommendation on 14 Oct. 2003, while XForms 1.1, which introduced a number of improvements, reached the same status on 20 Oct. 2009. Unlike the original HTML forms, the creators of XForms have used a Model-View-Controller approach. The “model” consists of one or more XForms models describing form data, constraints upon that data, and submissions. The “view” describes what controls appear in the form, how they are grouped together, and what data they are bound to. CSS can be used to describe a form's appearance. An XForms document can be as simple as an HTML form (by only specifying the submission element in the model section, and placing the controls in the body), but XForms includes many advanced features. For example, new data can be requested and used to update the form while it is running, but without scripting. The form author can validate user data against XML Schema data types, require certain data, disable input controls or change sections of the form depending on circumstances, enforce particular relationships between data, input variable length arrays of data, output calculated values derived from form data, prefill entries using an XML document, respond to actions in real time (versus at submission time), and modify the style of each control depending on the device they are displayed on (browser versus mobile versus text only, etc.). There is often no need for any scripting with languages such as JavaScript. Like HTML forms, XForms can use various non-XML submission protocols (multipart/form-data, application/x-www-form-urlencoded), but a new feature is that XForms can send data to a server in XML format. XML documents can also be used to pre fill data in the form. Because XML is a standard, many tools exist that can parse and modify data upon submission, unlike the case with legacy forms where in general the data needs to be parsed and manipulated on a case by case basis. XForms is itself an XML dialect, and therefore can create and be created from other XML documents using XSLT. Using transformations, XForms can be automatically created from XML Schemas, and XForms can be converted to XHTML forms. XForms can only be used on the server side as they are not supported by current browsers.

Unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

In addition, unless stated otherwise, terms such as, for example, “in response to” and “based on” mean “in response at least to” and “based at least on”, respectively, so as not to preclude being responsive to and/or based on, more than one thing.

In addition, unless stated otherwise, a “user device” may comprise any type of device that may be used by a user. Thus, a user device may have any form factor and may not be owned by and/or assigned to a user.

In addition, unless stated otherwise, a “database” may comprise one or more related or unrelated databases.

In addition, unless stated otherwise, data may comprise any type of information and may have and/or be stored in any form. In some embodiments, data may be stored in raw, excerpted, summarized and/or analyzed form.

Unless stated otherwise, a processing system may comprise any type of processing system. For example, a processing system may be programmable or non programmable, general purpose or special purpose, dedicated or non dedicated, distributed or non distributed, shared or not shared, and/or any combination thereof. A processing system may include, but is not limited to, hardware, software, firmware, and/or any combination thereof. Hardware may include, but is not limited to off the shelf integrated circuits, custom integrated circuits and/or any combination thereof. In some embodiments, a processing system will include at least one processor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. In some embodiments, a processing system will include at least one processor that executes instructions stored on the computer readable medium. A processing system may employ continuous signals, periodically sampled signals, and/or any combination thereof. If a processor is distributed, two or more portions of the processor may communicate with one another through a communication link.

Unless stated otherwise, a processor may comprise any type of processor. For example, a processor may be programmable or non programmable, general purpose or special purpose, dedicated or non dedicated, distributed or non distributed, shared or not shared, and/or any combination thereof. A processor may include, but is not limited to, hardware, software, firmware, and/or any combination thereof. Hardware may include, but is not limited to off the shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. In some embodiments, a processing may execute instructions stored on the computer readable medium. A processor may employ continuous signals, periodically sampled signals, and/or any combination thereof. If a processor is distributed, two or more portions of the processor may communicate with one another through a communication link.

In addition, unless stated otherwise, a communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols.

While various embodiments have been described, such description should not be interpreted in a limiting sense. It is to be understood that other embodiments may be practiced without departing from the spirit and scope of the invention, as recited in the claims appended hereto.

What is claimed is:

1. A method comprising:
receiving, by a processing system, requests for information from a plurality of user devices, each of the plurality of user devices having a user interface with capabilities, the capabilities of the user interface of each user device being different than the capabilities of the user interface of each of the other user devices;
providing, by the processing system, a plurality of sets of information, each of the plurality of sets of information including a plurality of items for potential display in a view provided by the user interface of a respective one of the plurality of user devices;
providing, by the processing system, information associated with the plurality of sets of information;
sending each of the plurality of sets of information to a respective one of the plurality of user devices; and
sending the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

2. The method of claim 1 wherein the providing information associated with the plurality of sets of information comprises providing a model that includes the information associated with the plurality of sets of information; and
wherein the providing a plurality of sets of information comprises providing a plurality of instances of the model, each of the plurality of instances of the model including a respective one of the plurality of sets of information.

3. The method of claim 1 wherein each of the plurality of user devices is further configured to determine visual characteristics for the at least one of the items displayed in the view provided by the user interface of the user device based at least in part on the information associated with the plurality of sets of information and the capabilities of the user interface of the user device, and to display the selected at least one item in the view provided by the user interface of the user device in accordance with the visual characteristics determined by the user device.

4. The method of claim 1 further comprising:
receiving, by the processing system, information from at least one of the user devices;
performing, by the processing system, at least one check of the received information based at least in part on the information associated with the plurality of sets of information.

5. The method of claim 1 wherein the information associated with the plurality of sets of information comprises information indicating the items of the plurality of items for which display in the view provided by the user interface of the user device is optional.

6. The method of claim 1 wherein a first one of the items is a first description of a subject, a second one of the items is a second description of the subject, the second description of the subject being longer than the first description of the subject, and wherein each user device of the plurality of user devices is configured to select only one of the first description of the subject and the second description of the subject for display in the view provided by the user interface.

7. A computer readable storage medium having instructions stored thereon, the instructions being executable by a machine to result in a method comprising:
receiving, by a processing system, requests for information from a plurality of user devices, each of the plurality of user devices having a user interface with capabilities, the capabilities of the user interface of each user device being different than the capabilities of the user interface of each of the other user devices;
providing, by the processing system, a plurality of sets of information, each of the plurality of sets of information including a plurality of items for potential display in a view provided by the user interface of a respective one of the plurality of user devices;
providing, by the processing system, information associated with the plurality of sets of information;
sending each of the plurality of sets of information to a respective one of the plurality of user devices; and
sending the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

8. The computer readable storage medium of claim 7 wherein the providing information associated with the plurality of sets of information comprises providing a model that includes the information associated with the plurality of sets of information; and
wherein the providing a plurality of sets of information comprises providing a plurality of instances of the model, each of the plurality of instances of the model including a respective one of the plurality of sets of information.

9. The computer readable storage medium of claim 7 wherein each of the plurality of user devices is further configured to determine visual characteristics for the at least one of the items displayed in the view provided by the user interface of the user device based at least in part on the information associated with the plurality of sets of information and the capabilities of the user interface of the user device, and to display the selected at least one item in the view provided by the user interface of the user device in accordance with the visual characteristics determined by the user device.

10. The computer readable storage medium of claim 7 further comprising:
receiving, by the processing system, information from at least one of the user devices;
performing, by the processing system, at least one check of the received information based at least in part on the information associated with the plurality of sets of information.

11. The computer readable storage medium of claim 7 wherein the information associated with the plurality of sets of information comprises information indicating the items of the plurality of items for which display in the view provided by the user interface of the user device is optional.

12. The computer readable storage medium of claim 7 wherein a first one of the items is a first description of a subject, a second one of the items is a second description of the subject, the second description of the subject being longer than the first description of the subject, and wherein each user device of the plurality of user devices is configured to select only one of the first description of the subject and the second description of the subject for display in the view provided by the user interface.

13. Apparatus comprising:
a processing system to (i) receive requests for information from a plurality of user devices, each of the plurality of user devices having a user interface with capabilities, the capabilities of the user interface of each user device being different than the capabilities of the user interface of each of the other user devices; (ii) provide a plurality of sets of information, each of the plurality of sets of information including a plurality of items for potential display in a view provided by the user interface of a respective one of the plurality of user devices, (iii) provide information associated with the plurality of sets of information, (iv) send each of the plurality of sets of information to a respective one of the plurality of user devices; and (v) send the information associated with the plurality of sets of information to each of the plurality of user devices, each of the plurality of user devices being configured to receive the respective one of the plurality of sets of information and the information associated with the plurality of sets of information, to select at least one of the items included in the respective set of information for display in a view provided by the user interface of the user device based at least in part on the information associated with the plurality of sets of information and the capabilities of the user interface of the user device, and to display the selected at least one item in a view provided by the user interface of the user device.

14. The apparatus of claim 13 wherein the processing system to provide information associated with the plurality of sets of information comprises a processing system to provide a model that includes the information associated with the plurality of sets of information; and
wherein the processing system to provide a plurality of sets of information comprises a processing system to provide a plurality of instances of the model, each of the plurality of instances of the model including a respective one of the plurality of sets of information.

15. The apparatus of claim 13 wherein each of the plurality of user devices is further configured to determine visual characteristics for the at least one of the items displayed in the view provided by the user interface of the user device based at least in part on the information associated with the plurality of sets of information and the capabilities of the user interface of the user device, and to display the selected at least one item in the view provided by the user interface of the user device in accordance with the visual characteristics determined by the user device.

16. The apparatus of claim 13 wherein the processing system is further to receive information from at least one of the user devices; and perform at least one check of the received information based at least in part on the information associated with the plurality of sets of information.

17. The apparatus of claim 13 wherein the information associated with the plurality of sets of information comprises information indicating the items of the plurality of items for which display in the view provided by the user interface of the user device is optional.

18. The apparatus of claim 13 wherein a first one of the items is a first description of a subject, a second one of the items is a second description of the subject, the second description of the subject being longer than the first description of the subject, and wherein each user device of the plurality of user devices is configured to select only one of the first description of the subject and the second description of the subject for display in the view provided by the user interface.

19. A method comprising:
sending, by a user device, a request for information;
receiving, by the user device, a set of information that includes a plurality of items for potential display in a view provided by a user interface of the user device;
receiving, by the user device, information associated with the set of information;
selecting, by the user device, at least one of the items included in the set of information for display in a view provided by the user interface of the user device based at least in part on the information associated with the set of information and capabilities of the user interface of the user device; and
displaying the selected at least one item in a view provided by the user interface of the user device.

20. A method comprising:
sending a request for information from a user device to a processing system;
receiving a set of information at the user device, the set of information including a plurality of items for potential display in a view provided by a user interface of the user device;
sending a request to submit information from the user device to the processing system; and
receiving a response at the user device confirming that the information from the user device was submitted.
